(19) United States
(12) Patent Application Publication
(10) Pub. No.: US 2015/0254998 A1
(43) Pub. Date: Sep. 10, 2015

(54) Training systems

(71) Applicant: Drexel University, Philadelphia, PA (US)

(72) Inventors: Christof Jurg Daetwyler, Philadelphia, PA (US); Dennis Howard Novack, Narberth, PA (US); Gregory James McGee, Glen Mills, PA (US)

(21) Appl. No.: 14/639,596

(22) Filed: Mar. 5, 2015

Related U.S. Application Data
(60) Provisional application No. 61/948,398, filed on Mar. 5, 2014.

(51) Int. Cl. G09B 19/00; G09B 5/14; G09B 5/06; G06F 3/0482; G06F 3/0484

(52) U.S. Cl. CPC G09B 19/00; G06F 3/0482; G06F 3/04842; G09B 5/06; G09B 5/14

(57) ABSTRACT

One aspect of the invention provides an interactive system for providing a training environment for a first user. The system includes a first computer system and a second computer system. The first computer system is programmed to display a first graphical user interface including multiple windows to a first user. The second computer system is programmed to display a second graphical user interface including multiple windows to a second user. The first computer system is further programmed to: display a video feed of the second user within one of the multiple windows in the first graphical user interface and capture and relay communications from the first user to the second user. The second computer system is further programmed to: display a video feed of the second user within one of the multiple windows in the second graphical user interface.

### CROSS-REFERENCE TO RELATED APPLICATIONS

This application claims priority to U.S. Provisional Patent Application Ser. No. 61/948,398, filed Mar. 5, 2014. The entire content of this application is hereby incorporated by reference herein.

### BACKGROUND

Physician-patient communication is key to effective patient care. A physician's communication skills determine the nature and quality of diagnostic information elicited from patients and the quality of the physician's counseling. Communication determines the patient's trust in the physician, which is strongly linked to patient adherence and satisfaction.

Effective communication is associated with positive health outcomes, including emotional health, symptom resolution, function, and physiologic measures such as blood pressure and blood glucose. Additionally, effective communication enhances physician satisfaction with medical visits; enhanced physician job satisfaction is, in turn, positively associated with patient adherence. Physician training in communication skills can enhance patients' emotional well-being.

While the cost of missed medical communication opportunities to health care organizations, taxpayers and insurance companies can be difficult to quantify precisely, it is estimated that $750 billion per year in the US is wasted on unnecessary heath care spending. This amounts to 30% of total health care costs. A 2012 Institute of Medicine report illustrates the extent of the health-care spending problem. A large portion of unnecessary spending is a result of missed prevention opportunities ($55 billion), unnecessary services ($210 billion) and inefficiently delivered services ($130 billion). All of these issues share at their nucleus an element of poor communication.

However, the “cost” of poor communication in health care also has intangible effects on patients and communities. Because physicians with poor communication skills often do not elicit and address patient concerns and mental health issues, their patients continue to suffer, take less “good care” of themselves, and often receive inadequate treatment(s). In several reports spanning 1997-2012, it was shown that fewer than half of patients receive clear information on the benefits and trade-offs of treatments for their condition, and fewer than half are satisfied with their level of control in medical decision making. There is also evidence that poor communication leads to unnecessary testing. Improved patient-centered communication in primary care visits has been correlated with fewer diagnostic tests and referrals, as well as with annual charges in the range of 33 percent lower.

Poor communication between physician and patient is also strongly associated with malpractice litigations. Poor communication between healthcare providers or within healthcare teams is a leading cause for medical error. CRICO, the patient safety and medical professional liability company owned by and serving the Harvard medical community, reports that they defend an average of 2.6 physicians per 100 physicians per year. Their total volume for the years 2006-2010 are 1,160 cases of which 484 (more than 40%) had communication factors. These communication dependent cases created costs of $264M—compared to $598M incurred costs for all cases.

Recognizing the need for effective health care communication, the National Board of Medical Examiners (NBME), which administers licensing examinations, implemented the Step 2 Clinical Skills (CS) examination for licensure in 2004. In this exam, the examinees encounter 12 actors or standardized patients (SPs) who portray patient cases. Each encounter allows 15 minutes to complete history taking and clinical examinations, and then 10 more minutes to write a patient note describing the findings, differential diagnosis and plans for testing. The exam takes place in special centers that are available in 5 cities: Philadelphia, Chicago, Atlanta, Houston, or Los Angeles. Due to this recent medical licensure requirement, all US medical schools now teach basic communication skills to prepare their students for this exam. Most schools accomplish this through facilitated encounters with SPs that are conducted in highly specialized facilities, consisting of multiple rooms configured as examination rooms and equipped with sophisticated audiovisual recording equipment. In addition, medical schools train and maintain a cohort of SPs. This capability comes at significant cost to the medical schools. It is estimated that a comprehensive training center for a medical school costs $1-$2 million to build and equip and approximately $1 million per year for ongoing expenses. All this investment pays out: almost 97% of US medical school graduates pass the LCME Step 2 CS exam and enter the residency equipped with basic clinical communication and examination skills.

The Accreditation Council for Graduate Medical Education (ACGME) mandates that all medical residency programs in the U.S. must provide evidence that their curriculum incorporates a number of competencies, including “Interpersonal and Communication Skills.” Residency programs must provide documentation of “a learning activity in which residents develop competence in communicating with patients and families that includes both a didactic component and an experiential component.” Among Drexel University College of Medicine affiliated residencies, twenty program directors take advantage of the Clinical Skills Education and Assessment Center (CEAC), to provide their residents with structured training and assessment with trained SPs. For this program, they must pay a fee of $250/per resident, and take a day or two off from their hospital duties, arrange patient care coverage and travel to a pre-clinical campus.

In addition to the 16,000 US medical school graduates that take the LCME licensing exam, each year 20,000 “independent” applicants compete for the 26,000 available residency positions. International medical graduates (IMGs) comprise the bulk of these applicants. IMGs often have not received any communication skills training. IMGs need to pass the LCME Step 2 CS to be licensed to practice in the US. However, 21% of IMGs fail this exam. Thus there is a great need in the IMG population for training to prepare for the exam. This need is being only marginally met by expensive training courses that impose large investments of time, money, and travel inconveniences on IMGs.

### SUMMARY OF THE INVENTION

One aspect of the invention provides an interactive system for providing a training environment for a first user. The system includes a first computer system and a second computer system. The first computer system is programmed to display a first graphical user interface including multiple windows to a first user. The second computer system is programmed to display a second graphical user interface including multiple windows to a second user. The first computer system is further programmed to: display a video feed of the second user within one of the multiple windows in the first graphical user interface and capture and relay communications from the first user to the second user. The second computer system is further programmed to: display a video feed of the second user within one of the multiple windows in the second graphical user interface; capture and relay communications from the second user to the first user; and display a scoring interface within one of the multiple windows in the second graphical user interface. At least one of the windows of the first user interface and one of the windows of the second user interface involved in the communication are synchronized.

This aspect of the invention can have a variety of embodiments. The first computer system can be further programmed to display a graphical representation of patient anatomy in at least one of the multiple windows of the first graphical user interface. The first computer system can be further programmed to detect a selection of a location or region of the graphical representation of patient anatomy and communicate that selection to the second computer system and the second computer system can be further programmed to display the selection in one of the windows of the second graphical user interface.

At least one of the first computer system and the second computer system can be further programmed to locally store the video feeds. At least one of first computer system and the second computer system can be further programmed to locally store other events. The other events can be multiplexed with the locally stored video feeds. The second computer system is further programmed to: receive a playback selection from the second user and communicate the playback selection to the first computer system. The first computer system can be further programmed to obtain locally-stored content corresponding to playback request and display the locally-stored content on the first graphical user interface. The playback selection can include at least a start time. The second computer system can be further programmed to: display one or more control widgets on the second graphical user interface; and upon manipulation of the one or more control widgets, communicate instructions to the first computer system to implement playback on the first graphical user interface based on manipulation of the control widgets on the second graphical user interface. The one or more control widgets can include one or more selected from the group consisting of: a scrollbar, a play button, a pause button, a fast-forward button, and a rewind button.

The first computer system and the second computer system can be programmed to communicate with each other using point-to-point communication.

The second user is a live standardized patient. The first user can be selected from the group consisting of a medical professional and a trainee standardized patient.

Another aspect of the invention provides an interactive system for providing a training environment for a first user. The system includes: a first computer system and a second computer system. The first computer system is programmed to display a first graphical user interface including multiple windows to the first user. The second computer system is programmed to display a second graphical user interface including multiple windows to a second user. The first computer system is further programmed to: display a video feed of the second user within one of the multiple windows in the first graphical user interface and capture and relay communications from the first user to the second user. The second computer system is further programmed to: display a video feed of the second user within one of the multiple windows in the second graphical user interface; capture and relay communications from the second user to the first user; display one or more control widgets on the second graphical user interface; and upon manipulation of the one or more control widgets, communicate instructions to the first computer system to implement playback on the first graphical user interface based on manipulation of the control widgets on the second graphical user interface.

This aspect of the invention can have a variety of embodiments. At least one of the windows of the first user interface and one of the windows of the second user interface involved in the communication can be synchronized. The one or more control widgets can include one or more selected from the group consisting of: a scrollbar, a play button, a pause button, a fast-forward button, and a rewind button.

Another aspect of the invention provides an interactive system for providing a training environment for a first user. The system includes: a first computer system and a second computer system. The first computer system is programmed to display a first graphical user interface including multiple windows to a first user. The second computer system is programmed to display a second graphical user interface including multiple windows to a second user. The first computer system is further programmed to: display a video feed of the second user within one of the multiple windows in the first graphical user interface; and capture and relay communications from the first user to the second user. The second computer system is further programmed to: display a video feed of the second user within one of the multiple windows in the second graphical user interface; and capture and relay communications from the second user to the first user. At least one of the first computer system and the second computer system are further programmed to locally store the video feeds. The second computer system is further programmed to: receive a playback selection from the second user and communicate the playback selection to the first computer system. The first computer system is further programmed to obtain locally-stored content corresponding to playback request and display the locally-stored content on the first graphical user interface.

This aspect of the invention can have a variety of embodiments. At least one of the windows of the first user interface and one of the windows of the second user interface involved in the communication can be synchronized. At least one of the first computer system and the second computer system can be further programmed to locally store other events. The other events can be multiplexed with the locally stored video feeds. The playback selection can include at least a start time.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 depicts an architecture of a system from a perspective of a user according to an embodiment of the invention.

FIG. 2 depicts an architecture of a system from an application perspective according to an embodiment of the invention.

FIG. 3 depicts an architecture of a system from an infrastructure perspective according to an embodiment of the invention.

FIG. 4 is a block diagram of an example device according to an embodiment of the invention.

FIG. 5 depicts an architecture according to an embodiment of the invention.

FIGS. 6-10 depict views of a learner's and standardized patient's physical equipment and/or screenshots according to embodiments of the invention.

FIG. 11 depicts exemplary data flows according to an embodiment of the invention.

FIG. 12 depicts exemplary data flows utilizing the WebRTC API according to an embodiment of the invention.

FIG. 13 depicts an administrative interface according to an embodiment of the invention.

FIG. 14 depicts a case authoring/editing interface according to an embodiment of the invention.

FIG. 15 depicts a log-in interface according to an embodiment of the invention.

FIG. 16 depicts a standardized patient (SP) sign-up page according to an embodiment of the invention.

FIGS. 17 and 18 depict an SP interface according to an embodiment of the invention.

FIG. 19 depicts an e-mail sent to an SP according to an embodiment of the invention.

FIGS. 20-23 depict scoring interfaces according to embodiments of the invention.

FIG. 24 depicts an interface for creating a new case according to an embodiment of the invention.

FIG. 25 depicts an interface for adding a new SP according to an embodiment of the invention.

FIG. 26 depicts an interface for adding a new administrator according to an embodiment of the invention.

FIG. 27 depicts a user interface according to an embodiment of the invention.

FIGS. 28 and 29 depict scheduling interfaces according to embodiments of the invention.

FIGS. 30 and 31 depict survey interfaces according to embodiments of the invention.

FIG. 32 depicts an encounter interface according to an embodiment of the invention.

FIG. 33 depicts a computing device according to an embodiment of the invention.

### DETAILED DESCRIPTION

There is a need for a system that provides high quality training in healthcare communication skills that is accessible outside of medical school settings. In the case of IMGs, the system should allow for preparation for the USMLE Step 2 CS without the need to travel to the US and spend money and time away from their family and workplace—and in case of residents and physician in the US, the system should allow for a very flexible scheduling so they can do the training when they find the time for it, and without spending time for travelling to a training center.

The system described herein provides an integrated system that seamlessly incorporates the interaction between a medical professional in training and a standardized patient, in a structured and reproducible manner.

The system provides the facilitation of remote audio/visual encounters between trainees and Standardized Patients (SPs) for the practice, assessment, and remediation of healthcare communication competencies. Specifically, the remote encounters with SPs, which can include actors who are trained to portray patients with medical/psychological conditions in a reproducible, standardized way, can enable practicing healthcare communication tasks, such as smoking cessation counseling, breaking bad news, and the like.

The encounters can include objective scoring. Such objective scoring can be objective, structured, reproducible scoring of healthcare communication competencies.

Structured feedback can then occur. This structured feedback can take the form of structured, personalized, high-quality feedback on the performance during the encounter. The feedback can be provided by a trained SP. The system can further include enhanced feedback. Enhanced feedback can include audio/visual enhanced feedback. For example, during the feedback session, the SP can play recordings of what the trainee was doing at select times when scoring was occurring. In addition, the SP can play prepared video vignettes to illustrate best practice(s).

The system provides the trainee and the administration with access to a complete recording of the encounter and the feedback session. This recording can feature a timeline that allows a user to jump directly to a specific time, such as the times when scoring was being performed (during encounter) and the respective scoring items being discussed (during feedback). The system can analyzes the performance and sends personalized learning assignments to the trainee. The system provides trainees an account page that can enable the scheduling of new encounters and provide access to past encounter scores and recordings. The system can enable an administration portal to provide for the set-up of trainees, SPs, cases, and scoring lists. Such a portal can also provide access to schedule future encounters, and review past encounters and to re-score past encounters. Further, the system can provide statistics on user performance per case and user surveys. The system can allow for training of SPs and can provide SPs with certifications to host encounters.

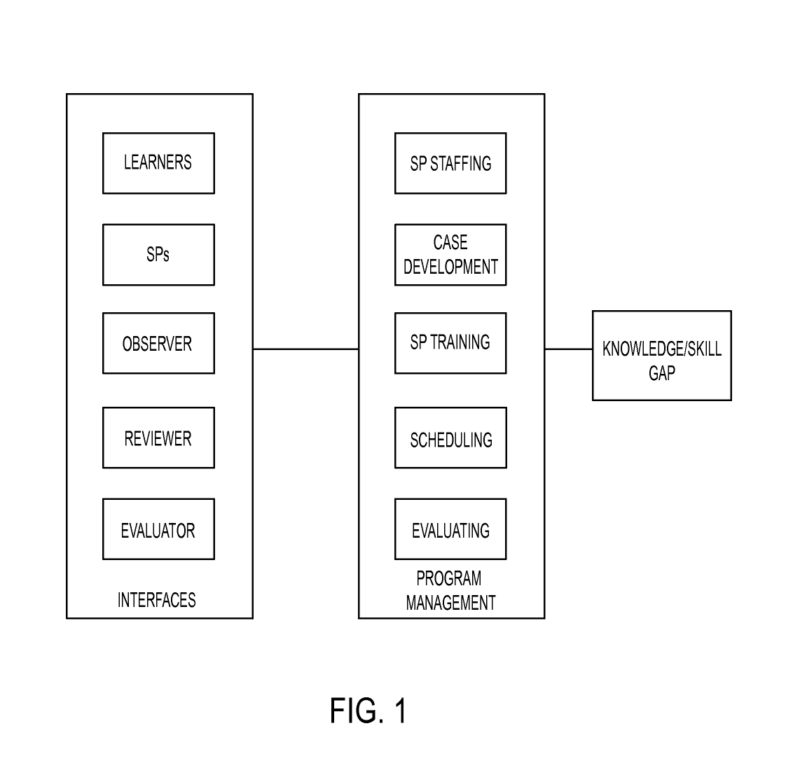

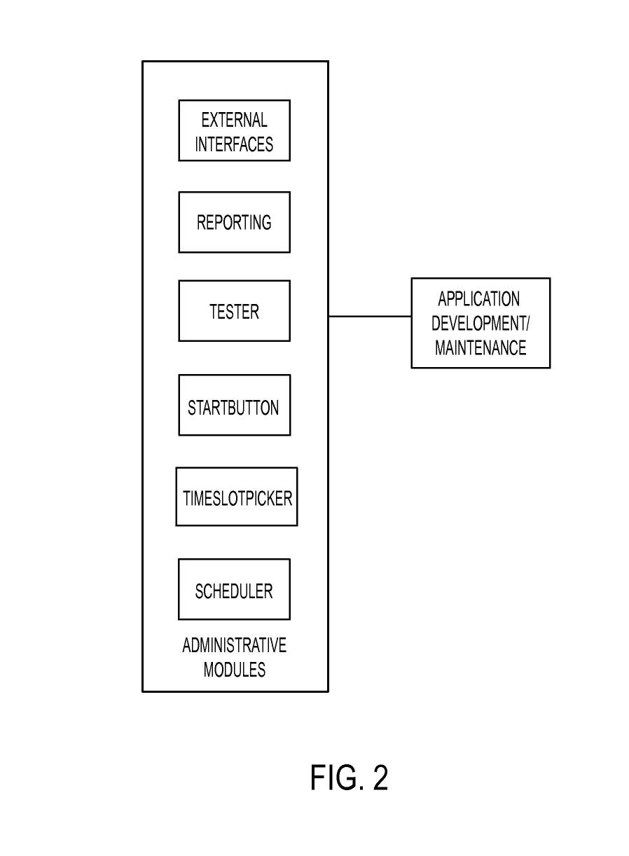

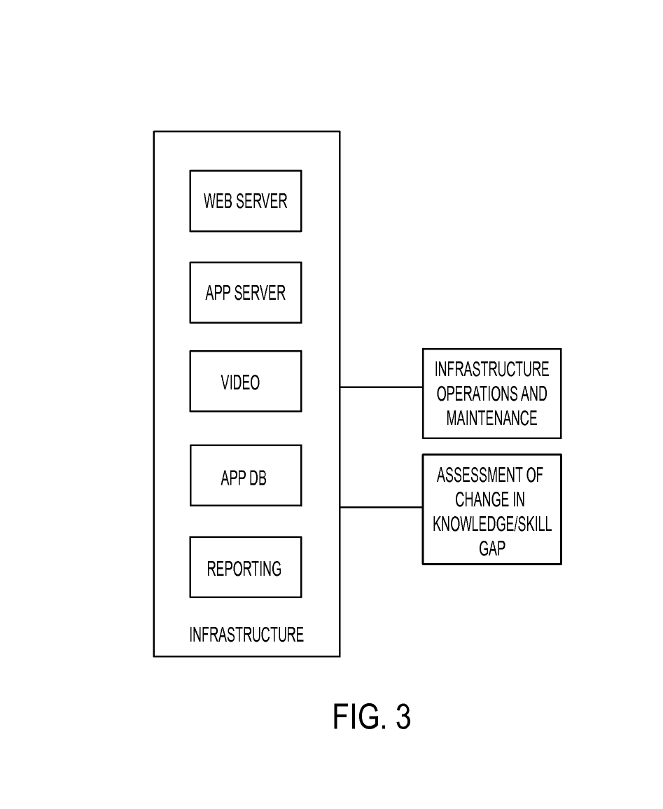

As illustrated cooperatively in FIGS. 1-3, the architecture of the present system can be viewed from the perspective of a user illustrated in FIG. 1, at an application level illustrated in FIG. 2, and based on infrastructure illustrated in FIG. 3. Referring specifically to the user level illustrated in FIG. 1, as illustrated in FIG. 1, standard patients (SPs) can interact with the system via a SP interface. Learners can interact via a learner interface. Observers, reviewers and evaluators can also interact via interfaces that can be configured specifically for the type of user they are, or a generic interface can be provided.

From program management, a knowledge or skill gap can exist. This can be in an individual such as the learner, or be a SP that is getting trained. Based on the knowledge gap, a case can be developed. This case can include specifics regarding an SP including staffing, training and scheduling of SPs. Further, the program management can provide for evaluation based on the skill gap.

The application level of the system is illustrated in FIG. 2. A plurality of administrative modules can be provided including a scheduler, a tester, a time slot picker, a start button, and a reporter. Each of these modules will be described in detail below. In addition, the application and modules can provide for external interfaces and application development and maintenance.

The infrastructure of the system is illustrated in FIG. 3. As shown the infrastructure can include a web server, an application server, video processors, application databases, output devices for reporting and the like as well as infrastructure operations and maintenance infrastructure. Each of the specific infrastructure units will be discussed herein below.

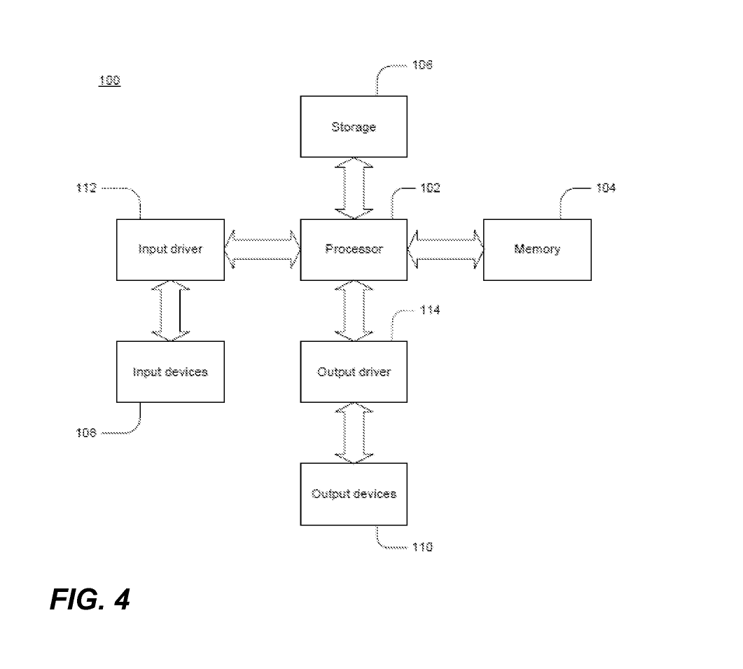

FIG. 4 is a block diagram of an example device 100 in which one or more disclosed embodiments can be implemented. The device 100 can include, for example, a computer, a gaming device, a handheld device, a set-top box, a television, a mobile phone, or a tablet computer. The device 100 can include a processor 102, a memory 104, a storage device 106, one or more input devices 108, and one or more output devices 110. The device 100 can also optionally include an input driver 112 and an output driver 114. It is understood that the device 100 can include additional components not shown in FIG. 4.

The processor 102 can include a central processing unit (CPU), a graphics processing unit (GPU), a CPU and GPU located on the same die, or one or more processor cores, wherein each processor core can be a CPU or a GPU. The memory 104 can be located on the same die as the processor 102, or can be located separately from the processor 102. The memory 104 can include a volatile or non-volatile memory, for example, random access memory (RAM), dynamic RAM, or a cache.

The storage 106 can include a fixed or removable storage, for example, a hard disk drive, a solid state drive, an optical disk, or a flash drive. The input devices 108 can include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 can include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 can operate in the same manner if the input driver 112 and the output driver 114 are not present.

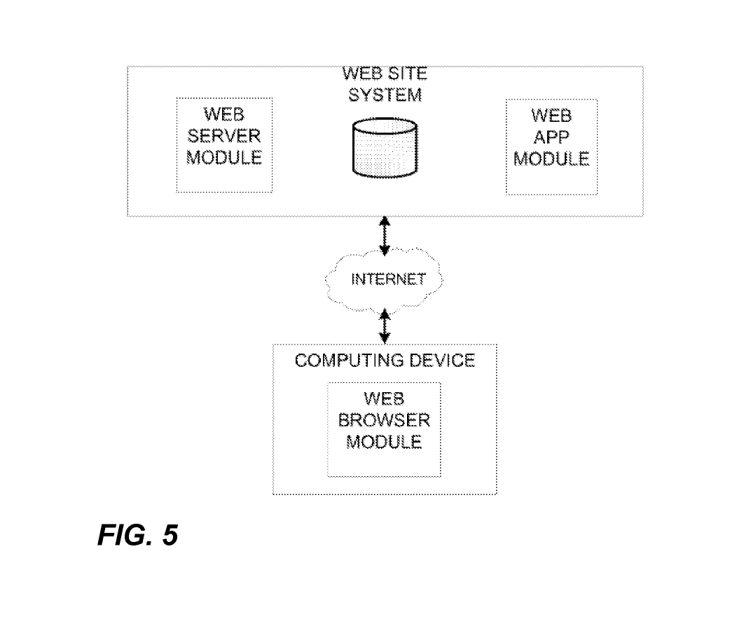

FIG. 5 shows an example architecture wherein features described herein can be implemented. The example architecture includes a web site system, a computing device, and the Internet. The web site system of FIG. 5 includes hardware (such as one or more server computers) and software for providing and/or hosting an interaction between a medical professional in training and a standardized patient, in a structured and reproducible manner as described. The computing device described above can be used to download and run a local application to access an encounter and interact with other users of the system. Alternatively, an end user can use the computing device to display and interact with the web pages that make up the interactive web site. The device shown in FIG. 5 can be, for example, a laptop or desktop computer, a tablet computer, a smartphone, a PDA, and/or any other appropriate type of device.

The web site system includes a web server module, a web application module, and a database, which, in combination, store and process data for providing the web site. The web application module can provide the logic behind the web site provided by the web site system, and/or perform functionality related to the generation of the web pages provided by the web site system. The web application can communicate with the web server module for generating and serving the web pages that make up the web site.

The computing device can include a web browser module, which can receive, display, and interact with the web pages provided by the web site system. The web browser module in the computing device can be, for example, a web browser program such as INTERNET EXPLORER®, FIREFOX®, OPERA®, SAFARI®, and/or any other appropriate web browser program. To provide the web site to the user of the computing device, the web browser module in the computing device and the web server module can exchange HyperText Transfer Protocol (HTTP) messages, per approaches that would be familiar to those persons of ordinary skill in the art.

Details regarding the interactive web site and the pages of the web site (as generated by the web site system and displayed/interacted with by the user of the computing device) are provided herein.

Registration to the site can be required in order to interact using the computing device. Users can create an account with the web site, and/or can log in via credentials associated with other web sites. With each user account, the user has a personal page. Via this page, users can establish “friends” links to other users, transmit/receive messages, and publish their bookmarks. Users can also publish in forums on the site, post comments, and create bookmarks.

The web site can include any number of different web pages, including but not limited to the following: a front (or “landing”) page, a search results page, an account landing page, and a screening window page.

Via the account landing page, the user is able to perform actions such as: set options for the user's account, update the user's profile, customize the landing page and/or the account landing page, post information, perform instant messaging/chat with other users who are logged in, view information related to bookmarks the user has added, view information regarding the user's friends/connections, view information related to the user's activities, and/or interact with the system.

Advertising can be integrated into the site in any number of different ways. As one example, each or any of the pages in the web site can include banner advertisements. Alternatively, video advertisements can be played, and/or be inserted periodically.

The components in the web site system (web server module, web application module, outgoing video module) can be implemented across one or more computing devices (such as, for example, server computers), in any combination.

The database in the web site system can be or include one or more relational databases, one or more hierarchical databases, one or more object-oriented databases, one or more flat files, one or more structured files, and/or one or more other files for storing data in an organized/accessible fashion. The database can be spread across any number of computer-readable storage media. The database can be managed by one or more database management systems in the web site system, which can be based on technologies such as MICROSOFT® SQL SERVER, MYSQL®, POSTGRESQL™, ORACLE® RELATIONAL DATABASE MANAGEMENT SYSTEM (RDBMS), a NoSQL™ database technology, and/or any other appropriate technologies and/or combinations of appropriate technologies. The database in the web site system can store information related to the web site provided by the web site system, including but not limited to any or all information described herein as necessary to provide the features offered by the web site.

The web server module implements the Hypertext Transfer Protocol (HTTP). The web server module can be, for example, an APACHE® web server, Internet Information Services (IIS) web server, LINUX® web server, and/or any other appropriate web server program. The web server module can communicate HyperText Markup Language (HTML) pages, handle HTTP requests, handle Simple Object Access Protocol (SOAP) requests (including SOAP requests over HTTP), and/or perform other related functionality.

The web application module can be implemented using technologies such as PHP: Hypertext Preprocessor (PHP), Active Server Pages (ASP), Java Server Pages (JSP), ZEND®, Python, ZOPE®, RUBY ON RAILS, Asynchronous JavaScript and XML (Ajax), and/or any other appropriate technology for implementing server-side web application functionality. In various implementations, the web application module can be executed in an application server (not depicted in FIG. 5) in the web site system that interfaces with the web server module, and/or can be executed as one or more modules within the web server module or as extensions to the web server module. The web pages generated by the web application module (in conjunction with the web server module) can be defined using technologies such as HTML (including HTML5), eXtensible HyperText Markup Language (XHMTL), Cascading Style Sheets, Javascript, WebRTC, and/or any other appropriate technology.

Alternatively or additionally, the web site system can include one or more other modules (not depicted) for handling other aspects of the web site provided by the web site system.

The web browser module in the computing device can include and/or communicate with one or more sub-modules that perform functionality such as rendering HTML, rendering raster and/or vector graphics, executing JavaScript, decoding and rendering video data, and/or other functionality. Alternatively or additionally, the web browser module can implement Rich Internet Application (RIA) and/or multimedia technologies such as ADOBE FLASH®, MICROSOFT® SILVERLIGHT®, HTML5 WebRTC, and/or other technologies, for displaying video. The web browser module can implement MA and/or multimedia technologies using one or web browser plug-in modules (such as, for example, an ADOBE FLASH® or MICROSOFT® SILVERLIGHT® plugin), and/or using one or more sub-modules within the web browser module itself. The web browser module can display data on one or more display devices (not depicted) that are included in or connected to the computing device, such as a liquid crystal display (LCD) display or monitor. The computing device can receive input from the user of the computing device from input devices (not depicted) that are included in or connected to the computing device, such as a keyboard, a mouse, or a touch screen, and provide data that indicates the input to the web browser module.

Although the example architecture of FIG. 5 shows a single computing device, in the present system this single computing device is only half of the encounter. That is, the single computing device of FIG. 5 can be coupled to a second computing device not shown. The use of a single computing device is done for convenience in description, and it should be understood that the architecture of FIG. 5 in can include, mutatis mutandis, any number of computing devices with the same or similar characteristics as the described computing device. Second, third and multiple computing devices in the present system can be coupled through a server, via point-to-point connection. In the present system, a first computing device can be operated by a trainer and a second computing device can be operated by a learner.

Although the methods and features are described herein with reference to the example architecture of FIG. 5, the methods and features described herein can be performed, mutatis mutandis, using any appropriate architecture and/or computing environment. Alternatively or additionally, although examples are provided herein in terms of web pages generated by the web site system, it should be understood that the features described herein can also be implemented using specific-purpose client/server applications. For example, each or any of the features described herein with respect to the web pages in the interactive web site can be provided in one or more specific-purpose applications. For example, the features described herein can be implemented in mobile applications for APPLE® IOS™, ANDROID®, or WINDOWS® MOBILE™ platforms, and/or in client application for WINDOWS®, LINUX®, or other platforms, and/or any other appropriate computing platform.

For convenience in description, the modules (web server module, web application module, and web browser module) shown in FIG. 5 are described herein as performing various actions. However, it should be understood that the actions described herein as performed by these modules are in actuality performed by hardware/circuitry (i.e., processors, network interfaces, memory devices, data storage devices, input devices, and/or display devices) in the electronic devices where the modules are stored/executed.

Specifically, the system described herein provides an online application for the training, assessment, and remediation of communication skills. The system can be provided using ADOBE FLASH® and ADOBE FLASH® MEDIA SERVER. Account and management pages can take the form of HTML pages and Javascript, with ASPNET running server-side. Data can be stored in a MICROSOFT® SQL database.

The system can provide remote communication skills training and assessment. The system can include web-based technology that facilitates remote encounters between medical students and/or residents and SPs for the practice, assessment, and remediation of medical communication skills. The system can be a functional part of the clinical experience in the clerkship/internship year.

The system can provide a step-by-step interaction as follows.

Step 1 can include establishing a remote connection. For example, at a scheduled time, the learner/assessee enters the system with ID and password. The assesse can connect remotely with the SP. After making sure that the audio and video connections work well, the SP can query if the task is understood, and upon acknowledgement begin the remote encounter and start the recording.

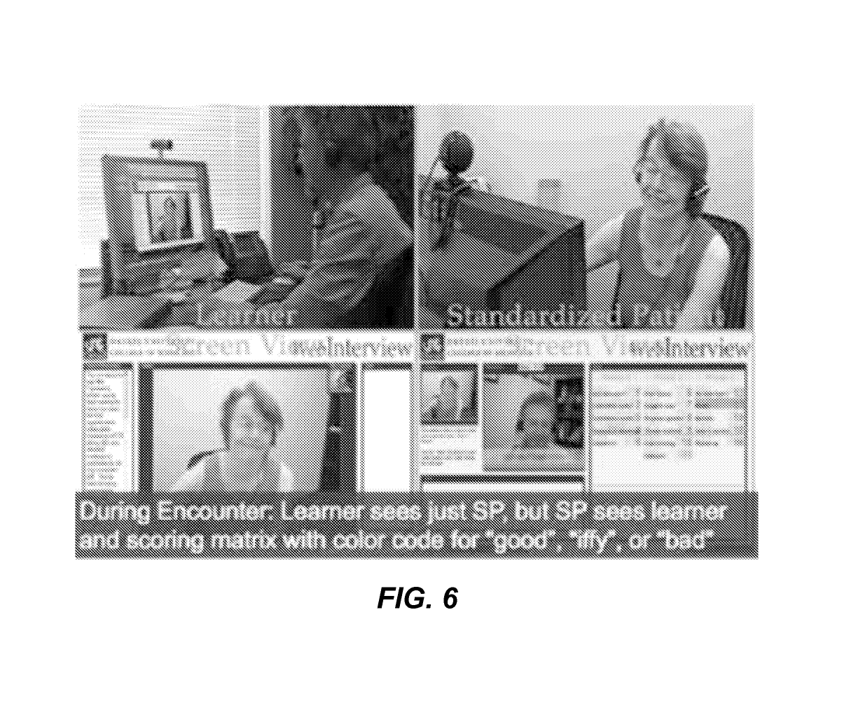

Step 2 can include the encounter with the SP. During the encounter, there are two different views. One view, shown on the lower left panel in FIG. 6 can be for the learner/assessee and the view shown on the lower right panel in FIG. 6 can be for the SP. The learner can be presented with a large video screen of the SP, so the subtle non-verbal communication can be accounted for. The SP can be presented with a “control” screen that shows the learner/assesse with name and a roster with color coded scoring items. The colors can allow scoring while maintaining eye-contact.

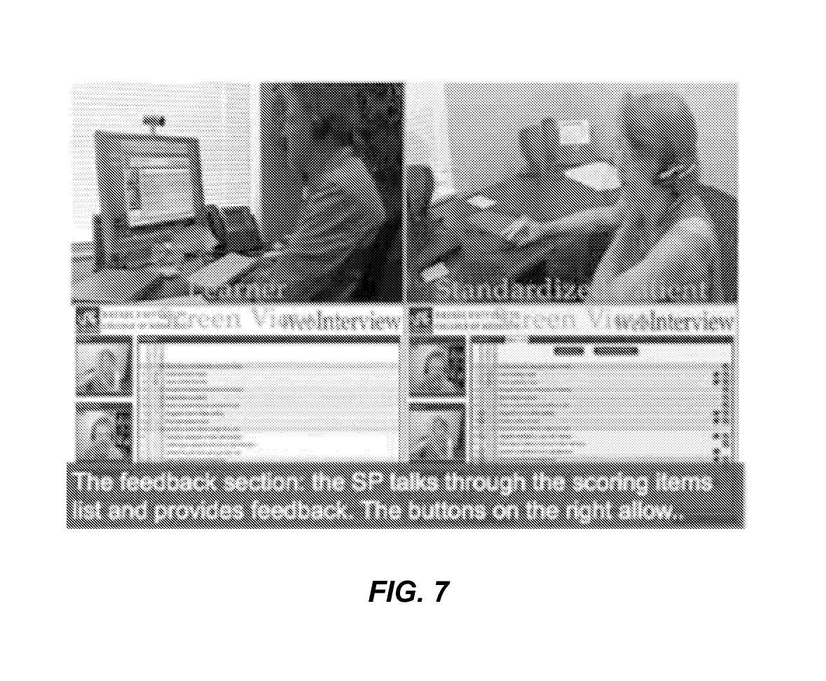

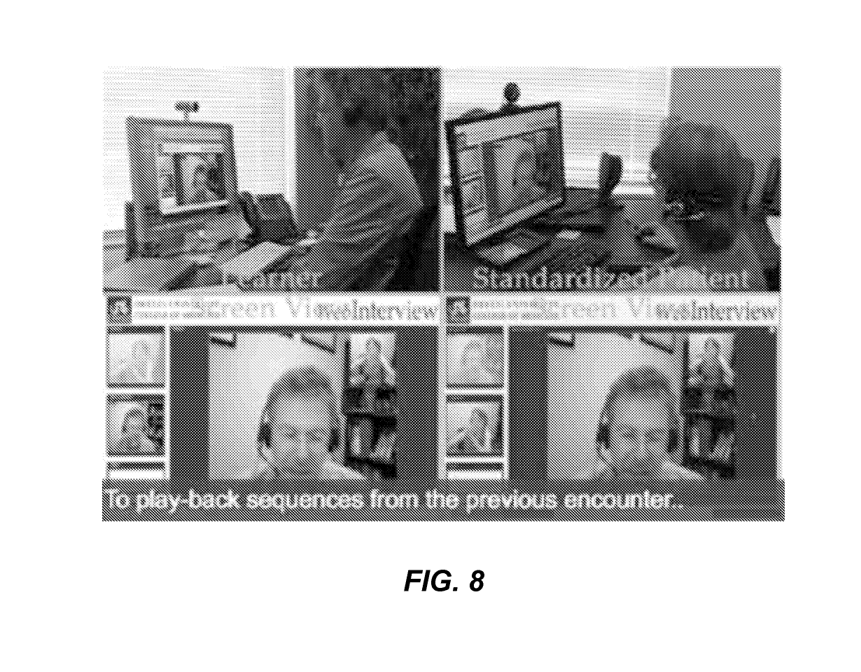

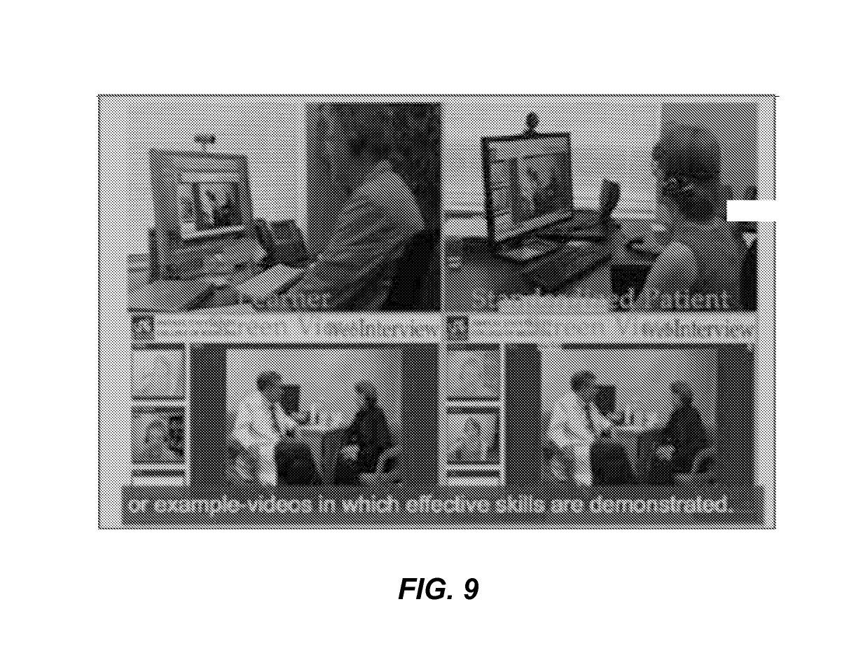

Step 3 can turn the table and allow the SP to provide feedback as illustrated in FIGS. 7-9. During the feedback section, the SP becomes a coach who provides the learner/assesse personalized high-quality feedback. Such feedback can include, for example, “In item 13, which is about providing praise for past successes, you got there right from the beginning . . . ” etc. When the SP sets the score, the line changes the color appropriately to either green, to identify tasks a being performed well, yellow, identifying tasks as partially well done, or red, identifying tasks that are not well done.

There can additionally be portions of the SP view, shown in the far right of the feedback list that is not there in the learner's list. These are buttons that allow the SP to start videos and can include two kinds of video buttons.

The first button can allow retrieval of a section of the recording of the encounter where the scoring was done. This retrieval can enable the SP to demonstrate to the learner/assessee what exactly was said or done by putting the learner/assesse back in the moment. For example, the illustration on the left shows that after initiating the playback of a section of the recording, both the learner/assessee and the SP watch the video together and continue the feedback discussion.

The second button can enable playback of prerecorded video vignettes that illustrate a sample of how the situation can be handled correctly. For example, the vignettes can provide an exemplary use of how the skills can be employed. Such vignettes can enable feedback that includes, for example, “Here is what you've done in this situation,” while playing a video using the first button to show the recording of the encounter, and here is what an experienced physician might do in a similar situation,” while playing a video using the second button to show a model encounter. This can enable a direct comparison of the learner/assessee's action with best behavior to provide a powerful learning experience.

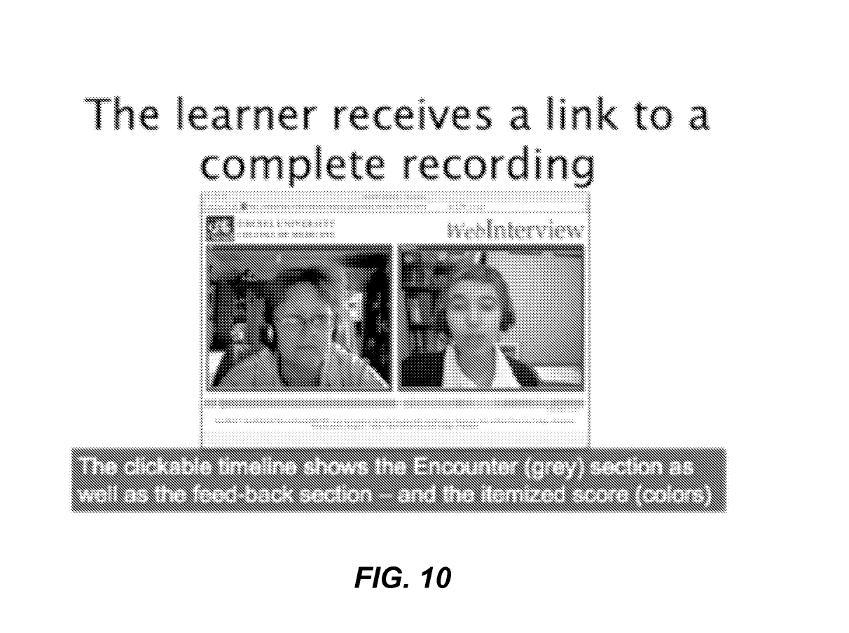

Step 4 can include providing a link to the recorded session as illustrated in FIG. 10. After the encounter, the learner/assessee receives a link to the recording of the complete encounter, which can include the feedback. In addition to direct feedback and the complete recording, the learner is provided with a link to a personalized web page that identifies which skills were performed well, and which were not. In case of the skills that were performed insufficiently, the learner/assesse can be provided links to educational materials that the learner can consult to improve in these areas. The system provides web access, live SPs, RT feedback, bookmarked video, and personal lesson plans, as well.

The system can allow a learner/assesse connected to the Internet with a computer equipped with a webcam to have a one-on-one medical encounter with a standardized patient. This encounter can be recorded in its entirety and available for subsequent review. In addition, the SP scores the learner/assesse in real time. The system is configured so that eye contact can be maintained at all times and is not disrupted when the SP enters data into the scoring checklist.

The feedback phase follows the encounter. During feedback, the SP becomes a coach who provides the learner/assessee with structured, feedback that is greatly enhanced by the ability of the system to playback segments of the recording that were recorded during the encounter. This playback provides the SP (now a coach) with the ability to show the assessee what exactly they were doing at the time that they received a low or high score on a specific skill during the assessment. The system also allows the SP to compare the learner's actions to prerecorded video examples of a physician role-model demonstrating an example of effective performance of the same skills.

After the system experience has ended, the learner/assessee can be provided with an email that contains hyperlinks to one or more personalized webpages. A first of these webpages can include the recording or a link thereto, of the complete encounter. This encounter can include the feedback session. Another webpage can be included with personalized learning assignments and hotlinks to text and videos that address the pitfalls identified during the encounter and associated feedback session.

The system client program can operate using ADOBE FLASH® Player, HTML5 WebRTC, or any other such software that has integrated webcam and microphone operability, and media streaming and recording capabilities. The client can interface with a server running FLASH® Media Server software or HTML5 WebRTC, for example. These technologies allow high quality real-time chat and on-demand video streams to be served to the client and handles data that is shared between clients and processes the recording of webcam streams.

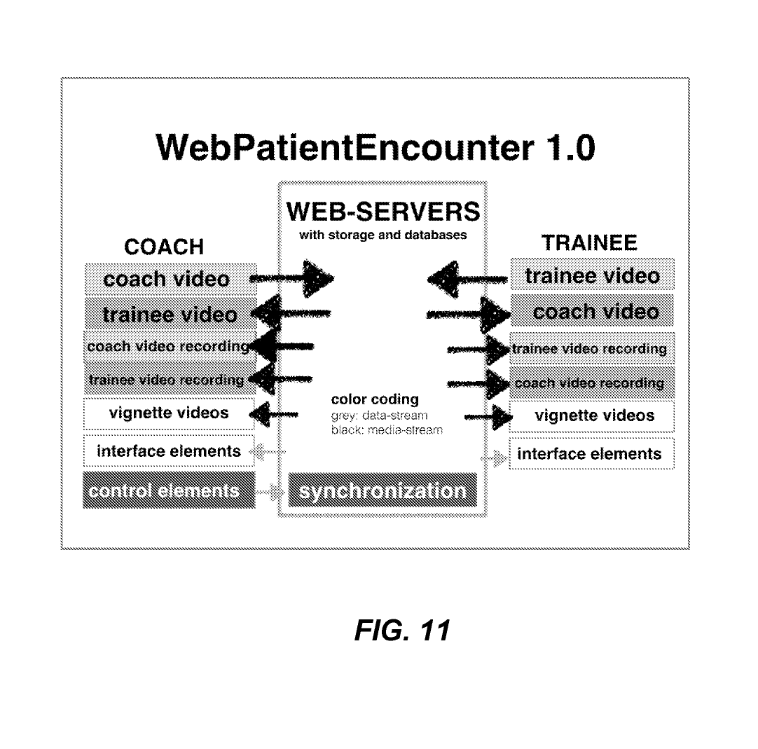

For example, as shown in FIG. 11 (WEB 1), the system communicates with a server over the Internet, such as by using Adobe's proprietary RTMP (Real-Time Media Protocol) and RTMFP (Real-Time Media Flow Protocol) protocols, which are extensions of TCP and UDP protocols, respectively. These protocols have been optimized for the transfer of audio and video data. A connection to the server using the RTMFP protocol allows for a more stable client-server connection that is less susceptible to disruptions caused by fluctuating bandwidth (e.g. on a Wi-Fi connection), and has the advantage of reduced latency, which decreases the communication delay between clients.

The account and management interfaces within the system can run on a WINDOWS SERVER® device running Internet Information Services. The server-side logic runs using Microsoft's ASP.NET technology. The client-side logic employs a combination of JQUERY® and custom JavaScript code. All persistent data is stored in databases on a MICROSOFT® SQL Server. Examples of persistent data include: accounts and passwords, records, scores, scenarios, checklists and time-stamped events. The system can be enabled to run on computers and laptops running, e.g., WINDOWS® or MAC OS® operating systems. Computers can include a webcam and microphone, which are used as the primary communication method between learners and assessors, and have network access.

Several methods have been used to ensure that the system's sessions are successful in less-than-optimal conditions. For example, many users run the program on a computer that is behind a corporate firewall, which often block ports or protocols that the system uses. In these situations, the system can cycle through all possible connection methods and ports in order to make a successful connection to the server. In addition, the system can automatically adjust the amount of data the video streams require to ensure stable communication on low-bandwidth connections. This adjustment can be performed by measuring the current bandwidth and latency and comparing it to optimal conditions, and then dividing the bandwidth allowance for the streams based on the difference between the detected statistics and the optimum.

Along with the account and management pages, the system can be split into several core applications including the SP and Learner interfaces, the Reviewer, which combines the stream and timestamp data to allow playback of recorded sessions, the Observer, which allows a 3rd party to view a session as it occurs, and the Evaluator, which combines the playback features of the Reviewer and the scoring features from the SP interface to allow assessment after the session is complete. The reviewer can be especially important if the SP did not score the learner or give feedback, for example. Other utility applications include the Scheduler, the TimeSlotPicker, the StartButton, and the Tester.

One of the design points in the system is to keep the input required from the learner to a minimum to avoid confusion and stress. In fact, in many cases once a session begins, the learner does not need to interact with the system. The learner's layout is synchronized with the SP's, who can guide the learner through each section remotely.

When an SP logs in, the SP can launch cases they are certified to run, view recordings of previous sessions, check their schedule and edit their availability to do encounters, and view demonstration recordings for the available cases. The SP can select a case, and press the ‘Start’ button to launch a session. If the SP desires to participate in an unscheduled ‘ad-hoc’ session, the SP can wait in the preparation section of the program for a learner to connect with them.

Similarly, when a learner logs in, the learner can access a list of cases the institution has made available, play back recordings of past sessions, and view scheduled sessions or schedule new sessions. Upon selecting a case, a button appears that checks if any SPs are logged in and have a session started for that case. If an SP is available, the button activates, plays a ringing noise, and puts a message in the browser letting the learner know an SP is ready. When the learner clicks the button, they are connected with the SP and can proceed through the session.

An alternate way for SPs and learners to connect is to schedule a session ahead of time. In this case, both parties are sent a link that references which SP and learner are participating and which case they are performing. When the SP opens the link, they are taken right into the session to wait for the learner to connect. When the learner opens the link, they see an inactive ‘Start’ button like on the main account page that activates when the SP starts the session.

The system can be divided into two sections, such as the interview, and the feedback. These sections can be recorded separately. The system can include the ability to play parts of the interview on-demand immediately after the interview concludes. During the interview, the SP can bookmark specific moments where checklist items are or are not utilized. These bookmarks are saved in the database to be referenced in the feedback section. The SP can then show the learner exactly what happened when the SP scored a particular item, reducing the opportunity for disputes or confusion. When videos are activated by the SP, the webcam streams coming from both sides pause to conserve bandwidth. The audio stream, which uses little bandwidth, remains uninterrupted.

While the SP sees the checklist with radio buttons to score each item, plus buttons to activate the example videos or bookmarked sections of the interview, the learner just sees the checklist with no interactive features. As the SP fills out the checklist, the learner sees the scores for each item appear as soon as the SP clicks the button. The SP can control which videos are viewed and when they're opened and closed, and the learner's screen synchronizes with the SP's actions. The learner's checklist can automatically scroll to match the SP's screen so that the learner does not lose place in the checklist.

The feedback section is optional if the learner is only being assessed. However, the scoring of sessions is not automatic, and if the feedback is not performed at the time, the learner cannot receive a score. In this case, an administrator or faculty member can evaluate the learner at a later time using the Evaluator feature available on the institution's management page.

Data must be shared between the SP and learner in real time, such as the available SPs in a case, to control which part of the session the SP is switching to, video stream names, bandwidth information, the state of the feedback checklist, and the like. The system is able to share this data between clients, which can ‘listen’ for changes made by other clients and handle those changes accordingly. This is how each action of the SP is reflected on the learner's screen, and allows for the remote control of what the learner sees without any user input.

Each event that occurs in the system is logged with a timestamp, such as when the SP switches to a different section, if a bookmark is made, a checklist item checked, a video played back, etc. These data points are used to ‘recreate’ a session after the fact, allowing for an accurate review of the session without having to capture a video of the client's screen. By piecing together the events during the interview, the system creates a timeline that uses dividers and colors to represent when the session moved to feedback, when each item was scored, which item it was, and the score given for that item, allowing someone to see the flow of the session and how well the learner performed.

The system includes a scheduling system, in which SPs can enter their availability using a calendar interface. They can enter times day by day, select date ranges in a month and set availability in bulk, or set a recurring time range, such as 2-5 pm every Tuesday and Thursday. The times are then broken up into ‘slots,’ which administrators can then assign to learners from the institution page. Learners can also pick slots themselves from their account pages.

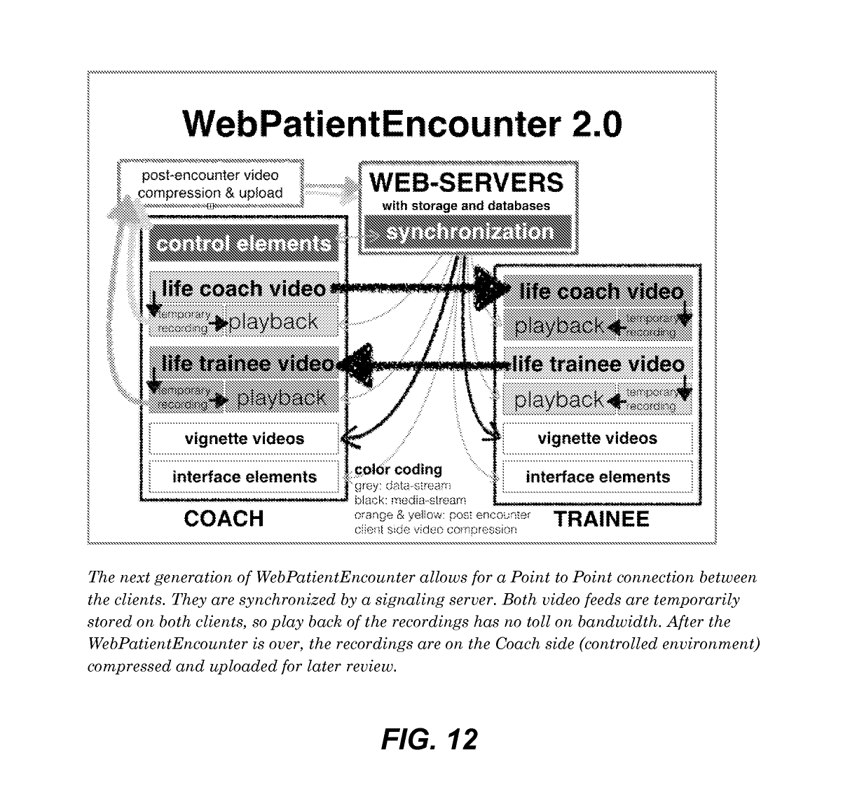

The system, as shown in FIG. 12 (WEB 2) can also utilize the WebRTC API that modern browsers are currently implementing.

WebRTC (Real-Time Communications) is a technology that allows for peer-to-peer (p2p) video, audio, and data streams over the Internet using a web browser without the use of extra software and is supported by, e.g., GOOGLE® CHROME™ and MOZILLA® FIREFOX® Internet browsers for WINDOWS®, MAC OS®, and ANDROID® operating systems. WebRTC uses a combination of technologies to process webcam and microphone data, to establish p2p connections in different network conditions, and to transmit the video and audio data with minimal latency and quality degradation. WebRTC is further described, for example, at http://www.webrtc.org/.

In order to establish a connection, clients (users) connect to a signaling server that acts as a gateway for the p2p connection. When another client connects to the signaling server, the server is able to let the first client know that another user connected, and allows them to establish the p2p connection. Once the p2p connection is established, the two clients can transmit data to each other directly. The signaling process continues to ensure connectivity and synchronization. The system can leverage this technology by reducing latency (communication delay), reducing bandwidth usage, simplifying the communication architecture, and improving stability.

Using a p2p paradigm reduces latency because the data does not need to travel up to a server and then down to the other client. The communication delay can be reduced. This client to server to client architecture facilitates real-time recording/encoding on the server so that the coach/trainee interview is immediately available for review during the session.

Using the WebRTC API reduces needed bandwidth by eliminating/or reducing the overhead needed when streaming over a TCP-based protocol (RTMP, a proprietary protocol developed by Adobe). Bandwidth is reduced by moving stream recording to the client by allowing both data streams to be captured by the client, allowing local recordings of the session to avoid needing to stream the recorded video/audio from the server.

Using a p2p system, the system can be run with less infrastructure. This makes the system more flexible and reduces hardware, software, electricity, and bandwidth costs.

The stability of the system can be improved by requiring less bandwidth from the clients, resulting in successful sessions on slow networks. In addition, the browser actively manages quality of service of the data transmission. This makes the program more lightweight and less error-prone.

The system can communicate with the server over the Internet using Adobe's proprietary Real-Time Media Protocol (RTMP) and Real-Time Media Flow Protocol (RTMFP) protocols, which are extensions of TCP and UDP protocols, respectively. These protocols have been optimized for the transfer of audio and video data. A connection to the server using the RTMFP protocol can allow for a stable client-server connection that is less susceptible to disruptions caused by fluctuating bandwidth (e.g. on a Wi-Fi connection), and has the advantage of reduced latency, which decreases the communication delay between clients.

The account and management interfaces for the system can run on a WINDOWS SERVER® device running Internet Information Services. The system's server-side logic can operate using Microsoft's ASP.NET technology. The client-side logic can employ a combination of JQUERY® and custom JavaScript code, for example. All persistent data can be stored in a database(s) on a MICROSOFT® SQL Server, for example. Examples of persistent data include: accounts and passwords, records, scores, scenarios, checklists and time-stamped events. The system can operate on computers and laptops running, e.g., WINDOWS® or MAC OS® operating systems, by way of non-limiting example only. Computers can include a webcam and microphone, which together are used as the primary communication method between learner/assessee and assessor(s). Computer network access with higher download speeds can enhance performance.

Several methods have been used to ensure that the system sessions are successful in less-than-optimal conditions. For example, many users run the program on a computer that is behind a corporate firewall, which often block ports or protocols that the system accesses. In these situations, the program cycles through all possible connection methods and ports in order to make a successful connection to the server. In addition, the system can automatically adjust the amount of data the video streams require to ensure stable communication on low bandwidth connections. Measurements of the current bandwidth and latency, and comparison of the measured values to optimal conditions can be performed. The bandwidth allowance can be divided for the streams based on the difference between the detected statistics and the optimum.

Along with the account and management pages, the system can be divided into several core applications. These core applications include the SP and Learner interfaces, discussed above, the reviewer, which combines the stream and timestamp data to allow playback of recorded sessions, the observer, which allows a third party to view a session as it occurs, and the Evaluator, which combines or multiplexes the playback features of the reviewer and the scoring features from the SP interface to allow assessment after the session is complete, such as if the SP did not score the learner or give feedback. Other utility applications include the scheduler, the time slot picker, the start button, and the tester.

The system maintains the input required from the learner to a minimum to avoid confusion and stress. In fact, in many cases once a session begins, the learner doesn't need to interact with the program at all. The learner's layout is synchronized with the SP's while the SP guides the learner through each section remotely.

When an SP logs in, the SP can launch cases to which they are certified, view recordings of previous sessions, check their schedule and edit their availability to do encounters, and view demonstration recordings for available cases. The SP can select a case, and press the ‘Start’ button to launch a session. If the SP desires to participate in an unscheduled ‘ad-hoc’ session, the SP can do so by waiting in the preparation section of the program for a learner to connect with them.

When a learner logs in, he can access a list of cases the institution has made available, play back recordings of past sessions, and view scheduled session(s) or schedule new session(s). Upon selection of a case, a button appears that checks if any SPs are logged in and have a session started for that case. If an SP is available, the system can provide a button, play a ringing noise, or otherwise alert the learner and puts a message in the browser letting the learner know an SP is ready. When the learner activates the system, they can be connected with the SP and to proceed through the session.

Another way for SPs and learners to connect is to schedule a session ahead of time. In this case, both parties are sent a link that references which SP and learner are participating and which case they are performing. When the SP opens the link, they are taken immediately into the session to wait for the learner to connect. When the learner opens the link, they see an inactive ‘Start’ button like on the main account page that activates when the SP starts the session.

The program is broken up into two main sections including the interview and the feedback. These sections can be recorded together or separately. Separately recording the sections can allow for the ability to play parts of the interview on-demand immediately after the interview concludes. During the interview, the SP can bookmark specific moments where checklist items are or are not utilized. These bookmarks are saved in the database to be referenced in the feedback section. The SP can then show the learner exactly what happened when the SP scored a particular item, reducing the opportunity for disputes or confusion. When videos are activated by the SP, the webcam streams coming from both sides pause to conserve bandwidth. The audio stream, which uses little bandwidth, can remain uninterrupted.

While the SP sees the checklist with radio buttons to score each item, plus buttons to activate the example videos or bookmarked sections of the interview, the learner can be provided a view with a checklist and no interactive features. As the SP fills out the checklist, the learner can be provided the scores for each item as the score is entered by the SP. The SP can control which videos are viewed and when the videos are opened and closed, and the learner's screen can be synchronized with the SP's actions. The learner's checklist can be enabled to automatically scroll to match the SP's screen so that the learner does not lose their place in the checklist.

The feedback section can be removed, or turned off, as can be the case if the learner is only being assessed. The scoring of sessions is not automatic, and if the feedback is not performed at the time of the encounter, the learner cannot receive a score. In this scenario, an administrator or faculty member can evaluate the learner at a later time via review of the video using the evaluator feature.

Data can be shared between the SP and learner in real time, such as the available SPs in a case, which part of the session the SP is switching to, video stream names, bandwidth information, the state of the feedback checklist, and the like. The system can be able to share data between clients. The clients can ‘listen’ for changes made by other clients and handle those changes accordingly. Each action of the SP can be reflected on the learner's screen, and can allow for the remote control of what the learner sees without any user input.

Each event that occurs in the program can be logged with a timestamp, such as when the SP switches to a different section. If a bookmark is made, or recorded, a checklist item can be checked, a video can be played back, or the like. Data can be used to ‘recreate’ a session after the fact, allowing for an accurate review of the session without having to capture a video of the client's screen. By piecing together the events during the interview, the program creates a timeline that uses dividers and colors to represent when the session moved to feedback, when each item was scored, which item was acted upon, and the score given for that item. Such a timeline can allow someone to see the flow of the session and how well the learner did.

The system can include a scheduling system. In this scheduling system, the SPs can enter their availability using a calendar interface, for example. The SPs can enter times day by day, select date ranges in a month and set availability in bulk, or set a recurring time range, such as 2-5 pm every Tuesday and Thursday, as well as other typical calendaring functions. Entered times can be broken up into ‘slots,’ which administrators can assign to learners. Learners can also pick slots themselves from their account pages.

Each component of the program and website is able to change its color scheme. This allows an institution to set a primary and secondary color and a web address pointing to a logo image, which the program can read as it loads and ‘brand’ the interface according to the user's institution.

The system provides a flexible platform for facilitating standardized medical encounters that are built upon carefully constructed, educationally sound cases with well-defined behavioral expectations, such as checklists. Cases can be custom built to fit the educational needs of an institution.

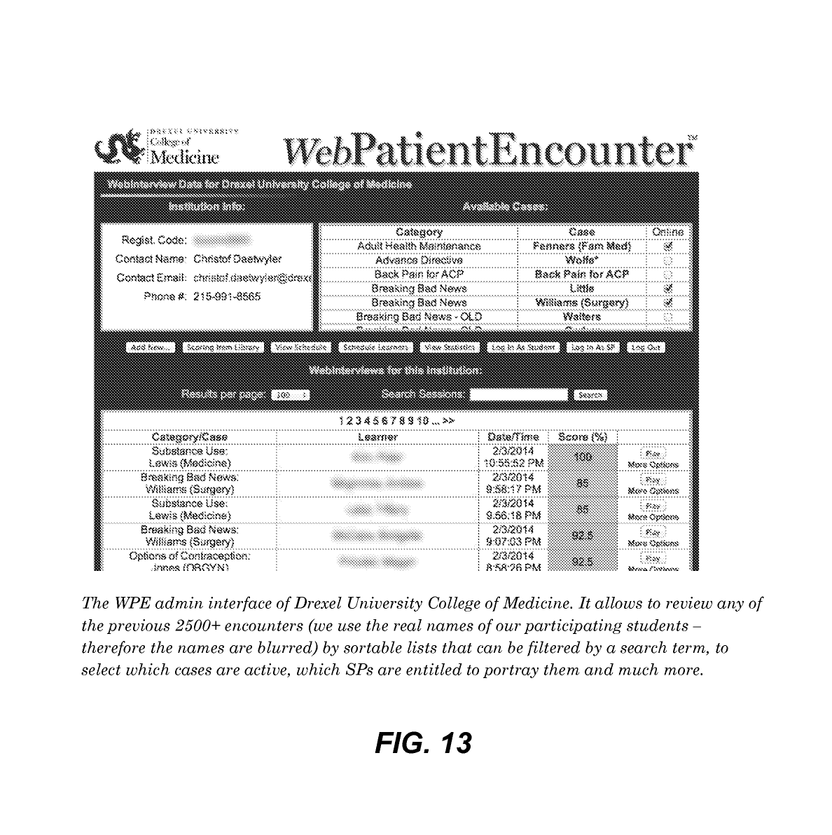

The system can provide an administrative interface as shown in FIG. 13. The interface of FIG. 13 can allow for review of any of the previous encounters by sortable lists that can be filtered by a search term to select which cases are active, which SPs are entitled to portray them and much more. The administrative interface for can be fully functional. The administrative interface can provide for independently adding and editing cases, to certify SP for representing the cases, and to review and score the encounters.

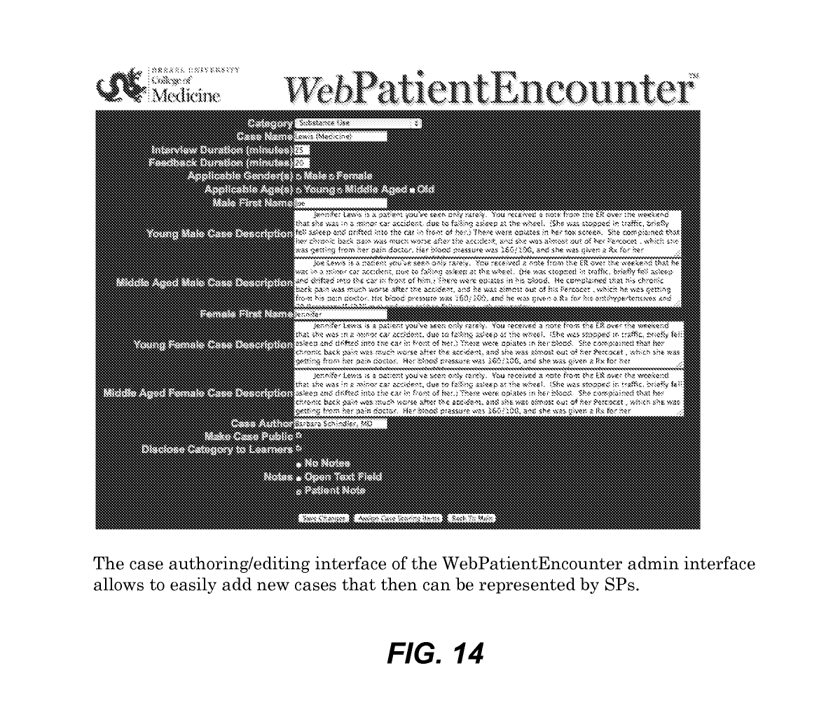

As shown in FIG. 14, the system can provide case authoring and deployment options. This interface shown in FIG. 14 can allow the ability to add new cases that then can be represented by SPs. For example, the following functionalities are available when choosing a case in the “available cases”: “Case Options” (allows the user to set up case details and checklist items), “Category”, “Case Name”, time available for the interview and the feedback (simple cases cannot require more than 10 minutes time for the encounter and can are for assessment only and don't have a feedback section, but cases for training counseling practices require up to 30 minutes for the encounter and up to additional 20 minutes for the feedback), a definition of who can portray the case (gender, age-group, other specs) in order to match Standardized Patients (SPs) representing a case with the correct case description, specifications for each SP group who can portray the case (young man, middle-aged man, old man; young woman, middle aged woman, old woman), a “Public” option that determines if a case is available to all institutions that are available under an instance of the system, a set “Disclose Category to Learners” option that determines if the case category is displayed or not, patient note options that determines if there is a patient note, and if there is one if it is free text or must fit into a common patient note structure, and a “Certify SPs for this case” that indicates that only SPs who are certified can host an encounter case.

For example: an ovarian cancer case can only be represented by a female SP and therefore only features a description for an encounter with a female SP. A smoking cessation case can be hosted by a male or female SP. Depending on whether the matched SP is male or female, the according case description is provided (e.g. “your patient is Ms. Jennifer Smolar, a 50 years old teacher . . . ” if the SP is a middle aged woman, but “your patient is Mr. Joe Smolar, a 78 years old retired police officer . . . ” if the SP is an older man).

When an SP receives certification, the date and the name of the certifying person are stored for further reference. Features for facilitating the on-line training of SPs when scaling up encounters: SPs in training who were set up. but have not yet received certification to host a case can portray the case to other SPs who are certified to host the case. This is an important feature to ensure scalability because most of the SP training happens on-line and it allows for building up several generations of SPs. To facilitate this, an uncertified SP who wants to practice a case can send out a request for training which is then automatically sent to all SPs who are certified on that case.

An “Approve Demo Recordings” option is available to SPs to identify an encounter that went especially well and flag it for inclusion as a demo encounter for further reference. The administrator of an institution can review the flagged encounters and decide which ones become Demo Recordings.

The button “Assign Case Scoring Items” on the bottom of FIG. 14 allows the user to enter scoring and feedback items and more as further described herein.

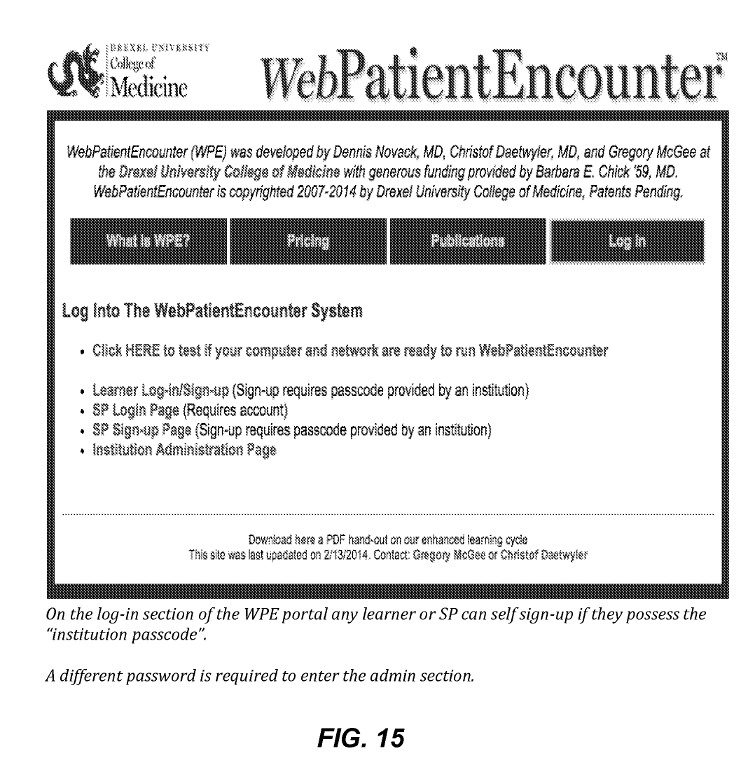

In developing cases, it can be important to train and monitor the workforce of SPs, while ensuring that SPs can be scaled up quickly and easily. When a case or encounter is configured, that case or encounter can be linked to an organization or entity, for example. Trainees of that entity can sign up for the cases/encounter by entering their entity code. Similar to the training of the trainee, SPs can be trained. The SPs can also sign up for an encounter or cases. For example, as shown in FIG. 15, an SP can log-in the interface and self-sign-up using the entity code.

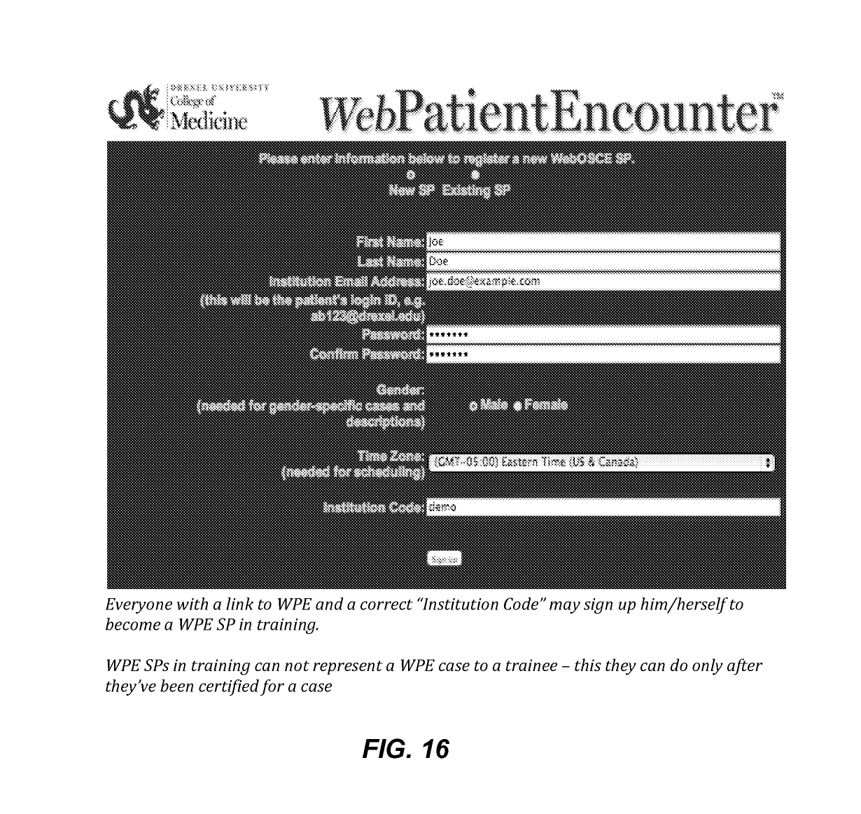

The SP can provide information regarding gender so that the correct cases and descriptions can be presented within the system. For example, for an ovarian cancer case, a limitation can be applied to ensure that the SPs are female. As shown in FIG. 16, new and existing SPs can register. Using the entity code, an SP can sign-up to become an SP in training. SPs in training can be prevented from presenting a case to a trainee until the in-training SP is certified for a case.

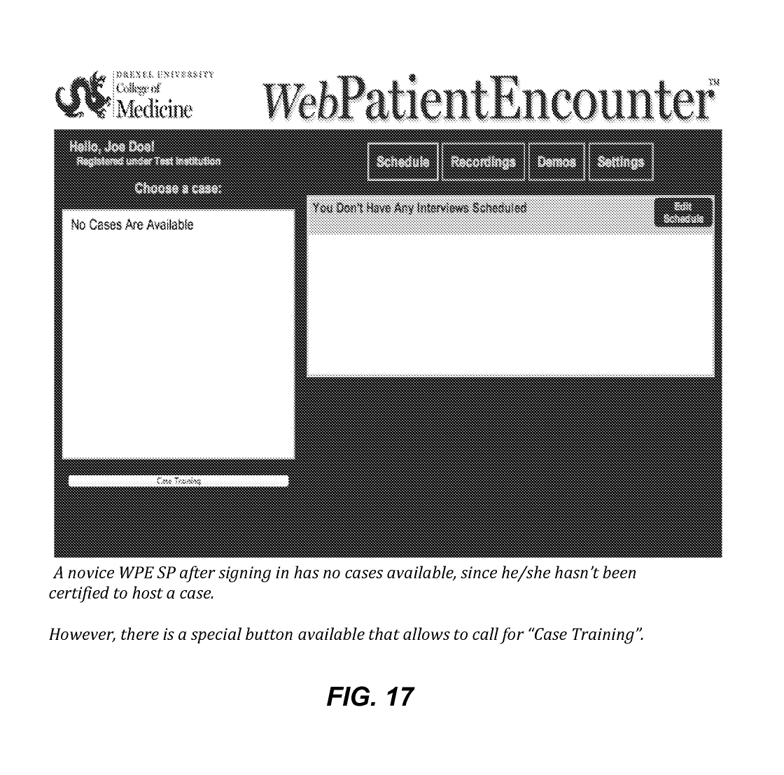

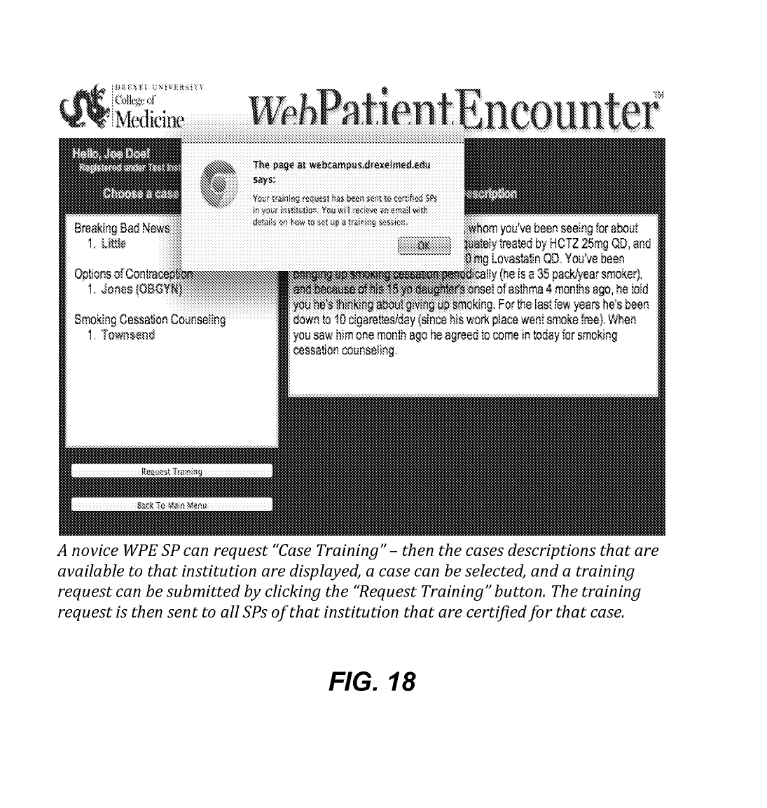

After the in-training SP has enrolled, there may be no cases for the SP to take on and present. As shown in FIG. 17, a special button can be initiated to register for Case Training. This can allow an SP to be trained and certified on a case prior to being allowed to become an available to present a case to a trainee. To facilitate online training of SPs, the novice SPs can view the case description of an entity. Once they find one or more case descriptions that fits the novice SP, the novice SP can study the case and practice the case online on a certified SP, until the novice SP is fit for certification. Once Case Training is initiated in FIG. 17, all available cases can be displayed as shown in FIG. 18. As shown the case descriptions that are available to that entity are displayed, allowing of a case to be selected, and a training request can be submitted by clicking the Request Training button. The training request can then be sent to multiple SPs of that entity that are certified for that case.

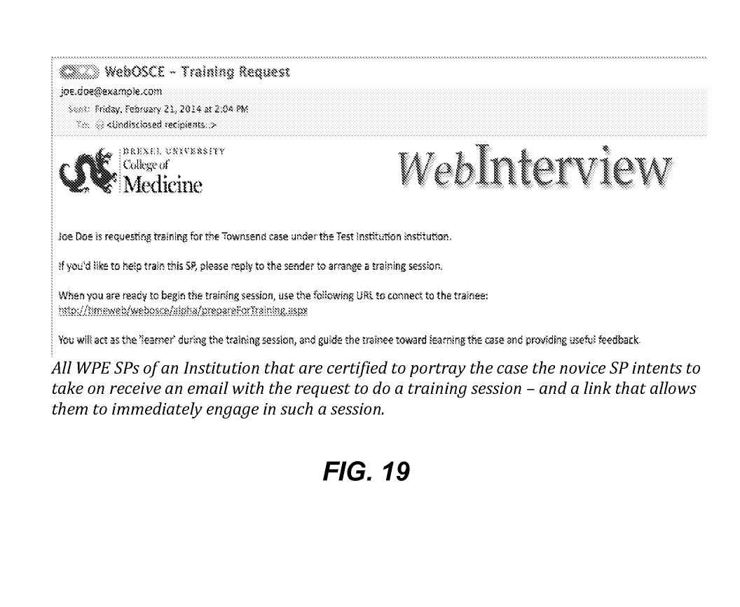

An email can be presented to the case certified SPs as shown in FIG. 19. This allows the certified SPs to portray a case in an online training session with the novice SP. The email can provide a link to directly link the certified SP to such a session. In the system, SPs can be provided payment for the time spent training novice SPs. Importantly, no administrative involvement was necessary to begin training the novice SP. In the training session, for example for at least the first few training sessions, the novice SP can assume the position of the trainees and the certified SP can assume the position of the SP/coach. This can provide the opportunity for the certified SP to provide the novice SP with feedback. Once the novice SP has learned the case and can represent it, the novice SP can begin to represent the case allowing the novice SP to get acquainted with the controls of the system and exercising live scoring. Once the certified SP concludes that the novice SP is ready to represent the case, an SP trainer or experienced faculty is contacted with the request to run the case with the novice SP, and once successfully completed allows the novice SP to become certified on the case. This allows the novice and now certified SP to present the case to a trainee. After each encounter, the trainees can be queried allowing the trainees to rate the quality of the case and how the performance of the SP rated. This allows scores to be monitored with respect to in-training SPs and certified SPs, thereby increasing system quality.

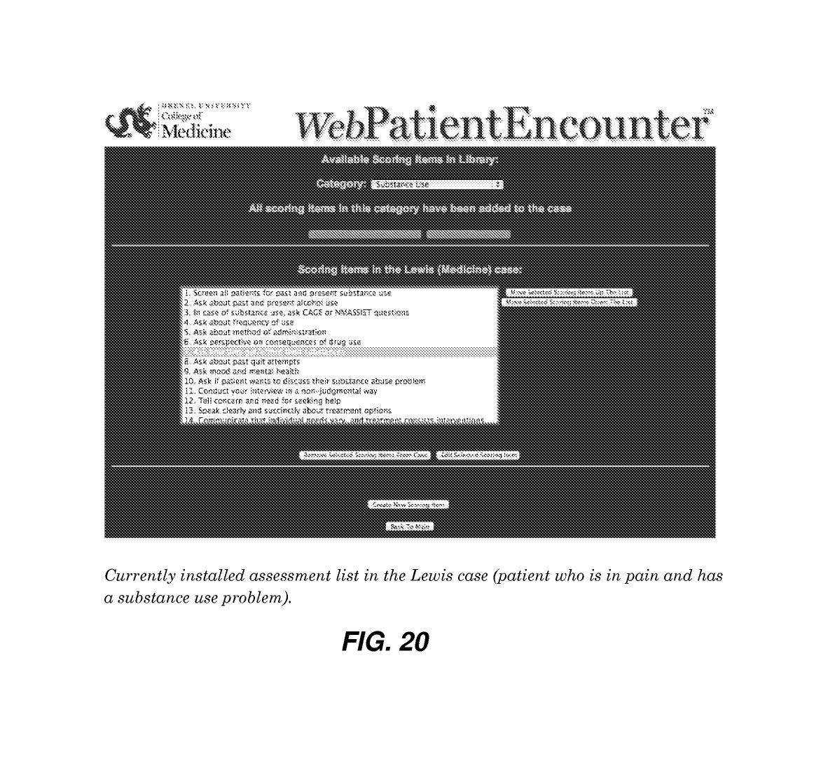

In using the system, scoring can occur. The creation of a case scoring list is illustrated in FIG. 20. As shown in FIG. 20, currently installed assessment list in the Lewis case (patient who is in pain and has a substance use problem) can be provided.

During an encounter, the trainees can be scored on the use of effective skills and on the knowledge demonstrated. In the encounter, lists of scoring items that are being used to assess a certain set of skills and knowledge (e.g. substance use, smoking cessation, delivering bad news) are grouped into categories and named accordingly. Scoring lists need to be developed only once per scoring category. The “scoring items”, “category”, and “library” options can be configured as follows. A scoring item describes a skill or piece of knowledge that can be present during an interaction (e.g. “sets up a follow up visit”, “asks when first cigarette of a day is consumed”, etc.). A skills items category, in the best case, is an evidence-based list of scoring items that allow the comprehensive assessment of competencies for that category. All categories containing all scoring items are contained in the scoring items library of the system.

The system allows selection of a scoring items category and adding references to all or a subset of the scoring items that are included in a case. The system enables easily adding scoring items from several categories into a case.

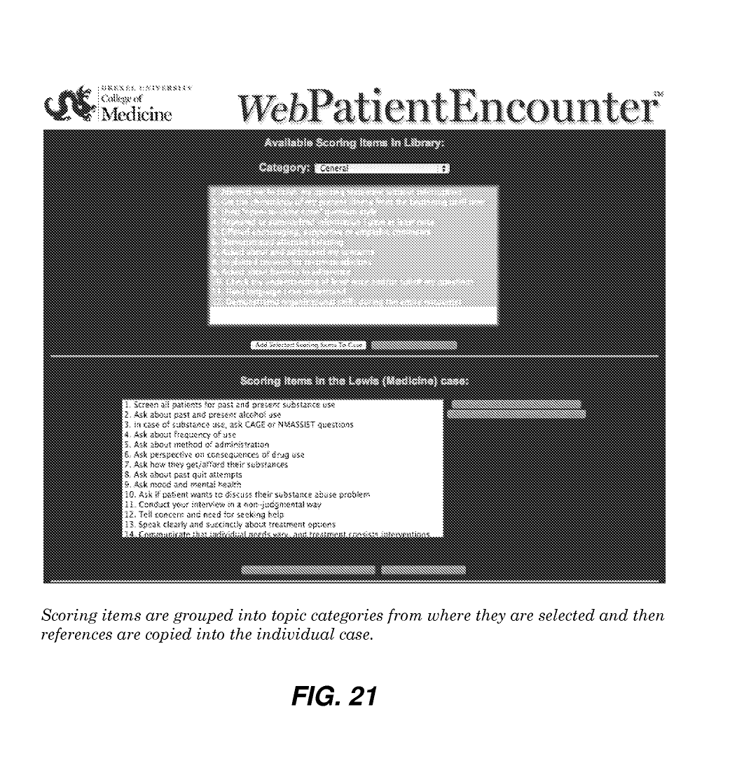

As shown in FIG. 21, scoring items can be included in the library. These scoring items can be grouped into topic categories in order to be selected and copied into an individual case. For example, a “General” category for the assessment of generic healthcare communication skills can be provided and added to any case in addition, to the case specific scoring category. Another example is to create a case of a patient with diabetes and hypertension starting by writing up a case description. Then, the scoring skills of the available categories “diabetes” and “high blood pressure” can be copied into the case.

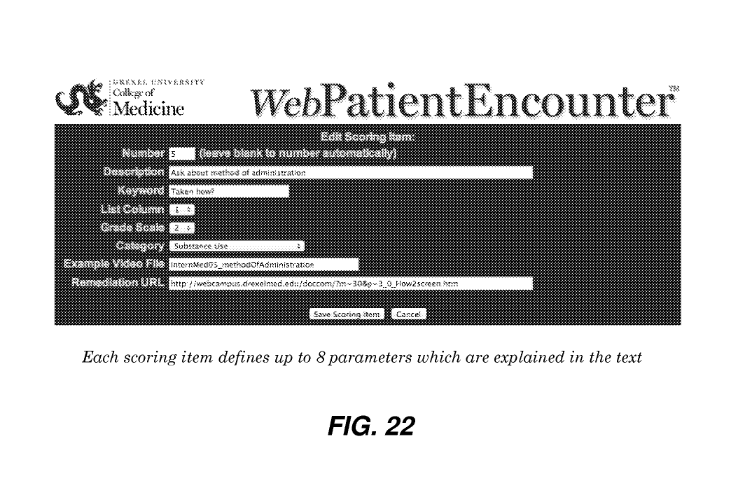

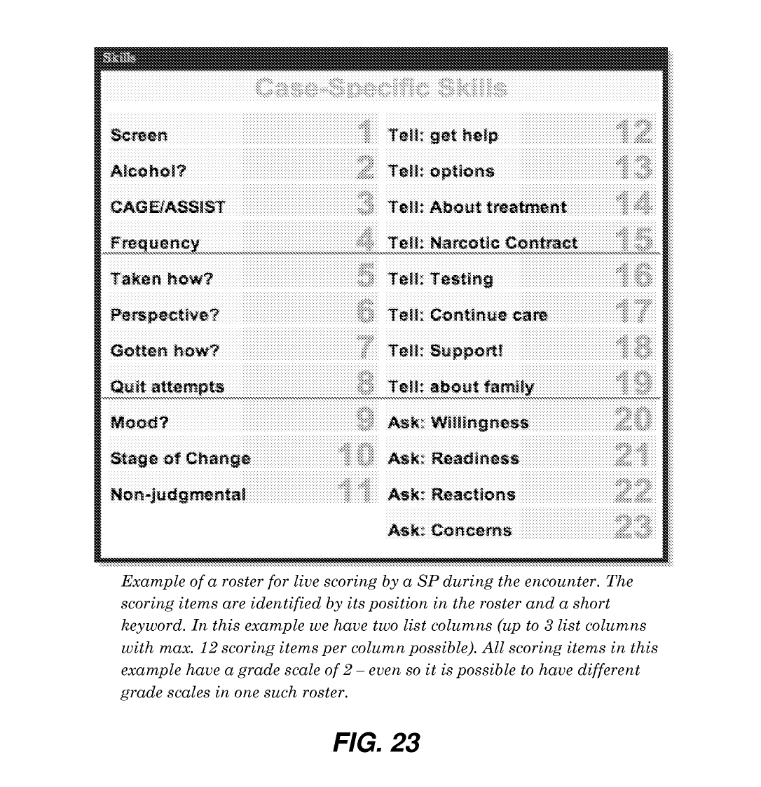

As shown in FIG. 22, each scoring item can define a number of parameters, such as eight, for example. In conjunction with FIG. 23, there is illustrated an example roster for live scoring by a SP during an encounter. The scoring items are identified by its position in the roster and a short keyword. In this example, there are two list columns (up to 3 list columns with a maximum of 12 scoring items per column possible). All scoring items in this example have a grade scale of 2—even so it is possible to have different grade scales in one such roster. The FIGS. 22 and 23 illustrate an interface which an administrator adds and/or edits a single scoring item. The system can be configured to affects all instances where this scoring item is being used or just the scoring item for specific cases. By way of example, each scoring item can be described by up to 8 parameters. This can include a number that defines where the item shows up in the scoring list, a description that shows up in the feedback list, a keyword that shows up in the live scoring roster that the trainee uses, a list column that defines in which column of the live scoring roster it is displayed, a grade scale that defines if a 2- (yes/no), 3- (yes/partially/no), or 5-item scale are used, a category that defines to which overarching assessment category this item belongs, an example video file that is a name of vignette video to play during feedback, and a remediation URL for on-line learning resources that educates about the issue that is being assessed by the scoring item. This is used to auto-generate learning assignments.

Option buttons can be created and displayed on the system interface. Such option buttons can provide a user with ease of workflow by adding commonly accessed buttons. These option buttons can include different functionalities all over the spectrum of the system.

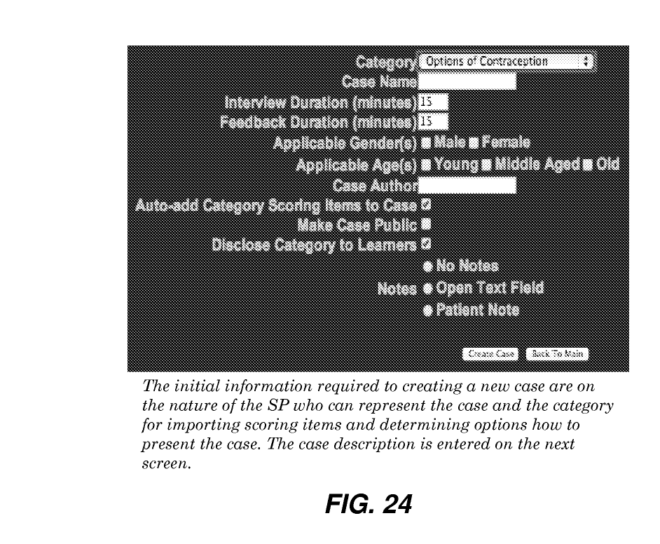

Adding a new button allows for the direct creation of a new case, shown in FIG. 24. The initial information necessary to create a new case including information about which SPs can present the case and the category for importing scoring items and determining options how to present the case can be entered by creating a new case.

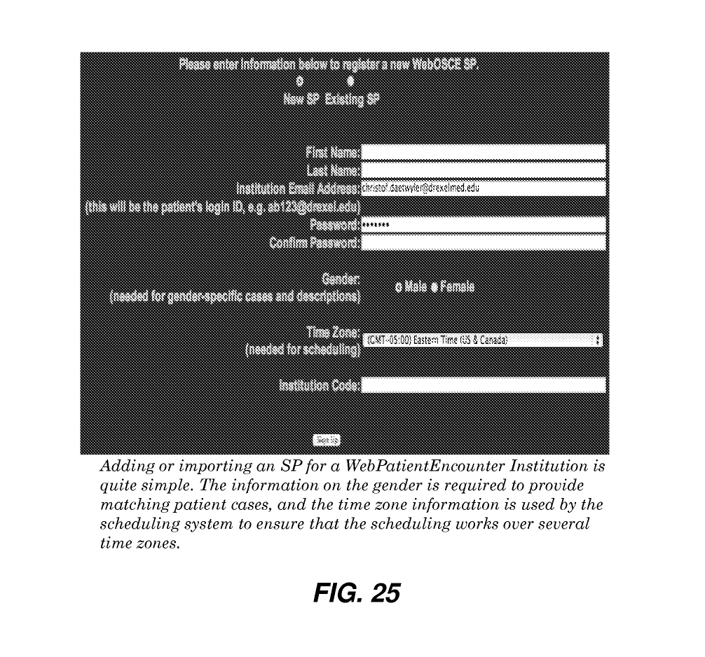

A new button can be created to add a new SP as illustrated in FIG. 25. Adding or importing an SP for an encounter can be performed by providing information regarding the gender and the time zone. The gender information can be used to provide matching for patient cases. The time zone information can ensure that the scheduling works over several time zones.

Adding a new student/trainee can also be accomplished. The steps for doing so can be created to be similar to adding a new SP. However, adding a new trainee may not require or benefit from including gender information. User information from another database can be linked by keying on the email address under which the trainee can be reached, for example.

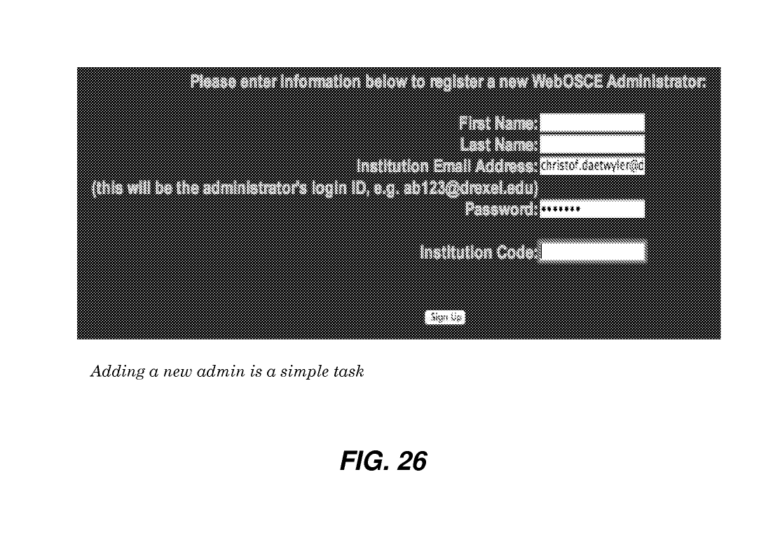

A new administrator can also be added as illustrated in FIG. 26. This information can be entered directly or received from a database.

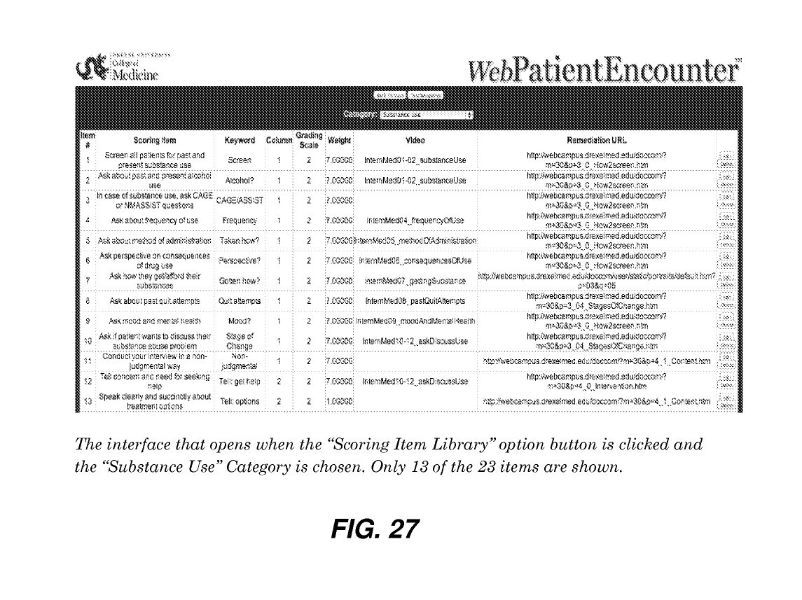

As shown in FIG. 27, there is illustrated an interface that opens when the scoring item library option is initiated and by way of example, the substance use category is chosen. This scoring item library provides for the editing of scoring items and to group items into categories. This feature can allow an administrator to review and edit a group of scoring items with options that are grouped into a category. Within a category, the scoring items can be accorded different weights so that important skills/knowledge can have a bigger impact on the resulting score. The assigned weights for items can be changed. For example, all items can be accorded equal weight or certain items can be accorded double the weight of other items.

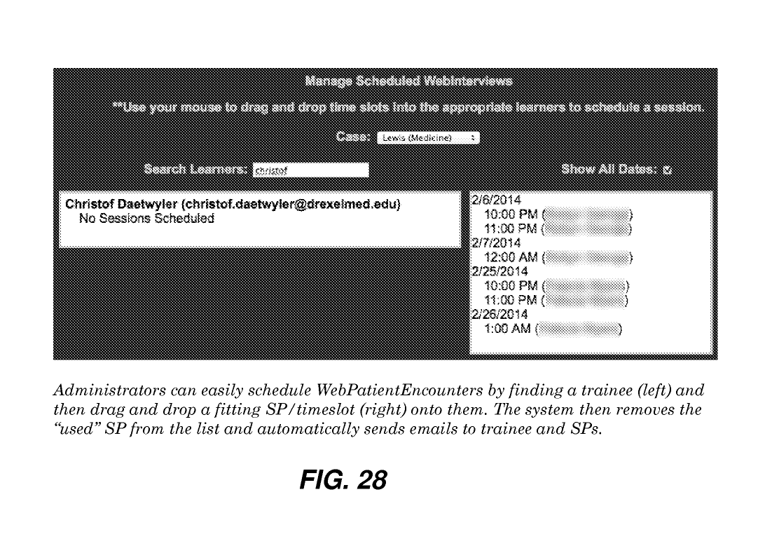

As shown in FIG. 28, learners can be scheduled. Learners can be trainees and/or assessees, for example. As illustrated in FIG. 28, scheduling learners allows the system to schedule trainees to match SPs. After trainees are registered for encounters, the trainees can be matched and scheduled with an available SP. To facilitate this process, the encounter can require the SPs to enter their availability into a scheduling database. The scheduling database can then be used together with the information which SP is certified to hosting a certain case to produce the following interface screen of FIG. 28. An administrator can survey the SPs' availability and enter the availability into the system. Then the administrator can enter the students and uses the “schedule learner” to schedule the encounter. An interface for uploading scheduling information directly from any table can also be used in the system enabling the scheduling to be done directly either by hand or by interfacing with another system.

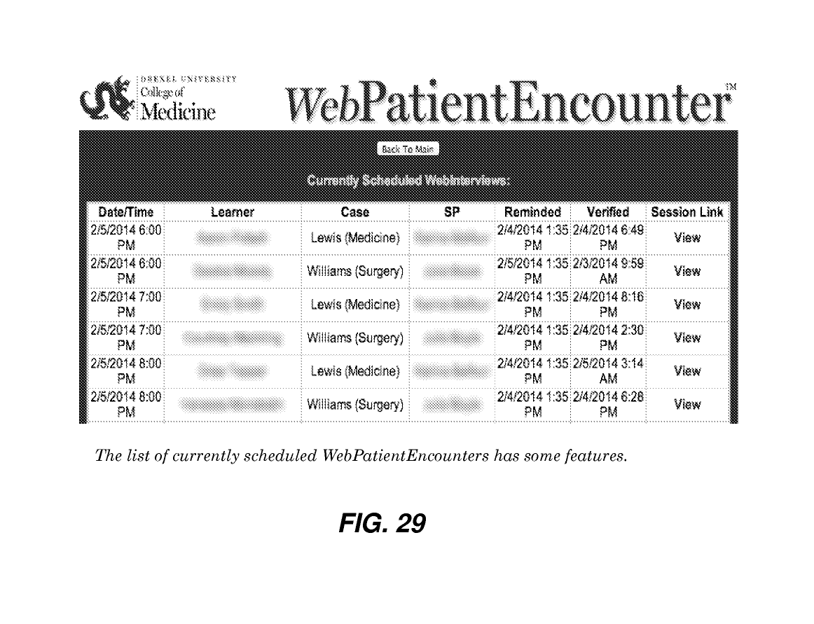

The system also provides an interface for viewing scheduled encounters. FIG. 29 depicts an interface showing upcoming encounters. Conducting encounters with busy clinicians, residents, medical students in their clerkship year, and other health care professionals is aided because the system provides a list of future encounters including when the encounter is to happen, what case the encounter pertains to, and when or if the trainee has been reminded of the encounter. A verification process can be included to force the trainees to find a working Internet connection, and a session link within which the encounter can be started bypassing the verification process.

The verification process can assure that the available Internet connection is sufficient to allow for a successful encounter. The “verification process” includes an automated reminder email sent one week before the session and again the day before the session requesting that the students perform a connection and webcam/microphone test to verify that their Internet connection meets requirements to run an encounter. If the user doesn't pass this process, the system prompts them keep trying. Once verified, they are sent the link to their session. Students must have this link to start the session. This functionality is optional, but is particularly advantageous when there is no control over the quality of the Internet connection on the trainee side.

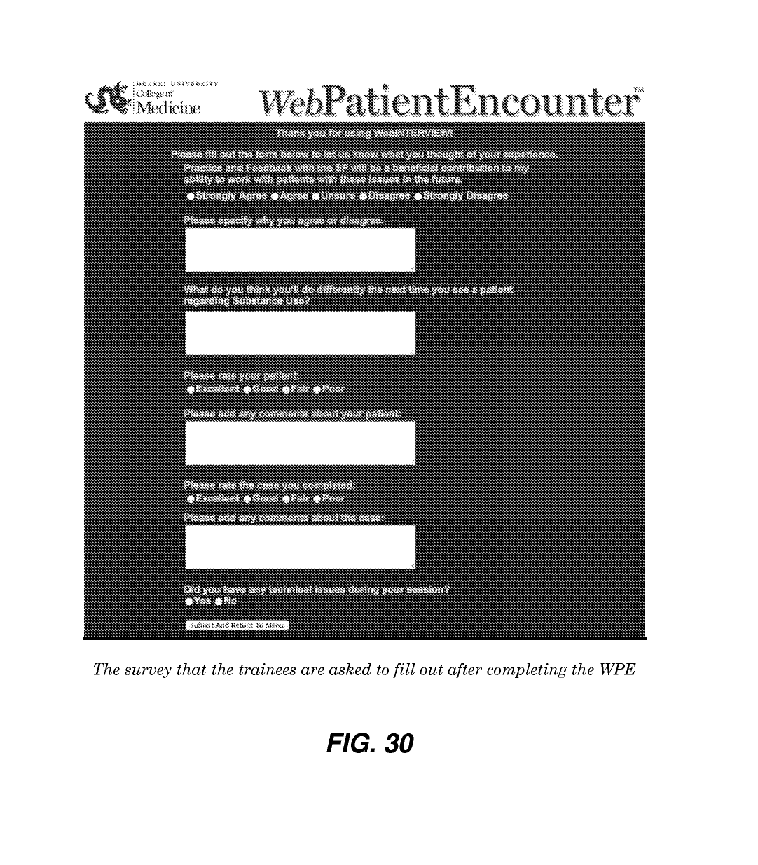

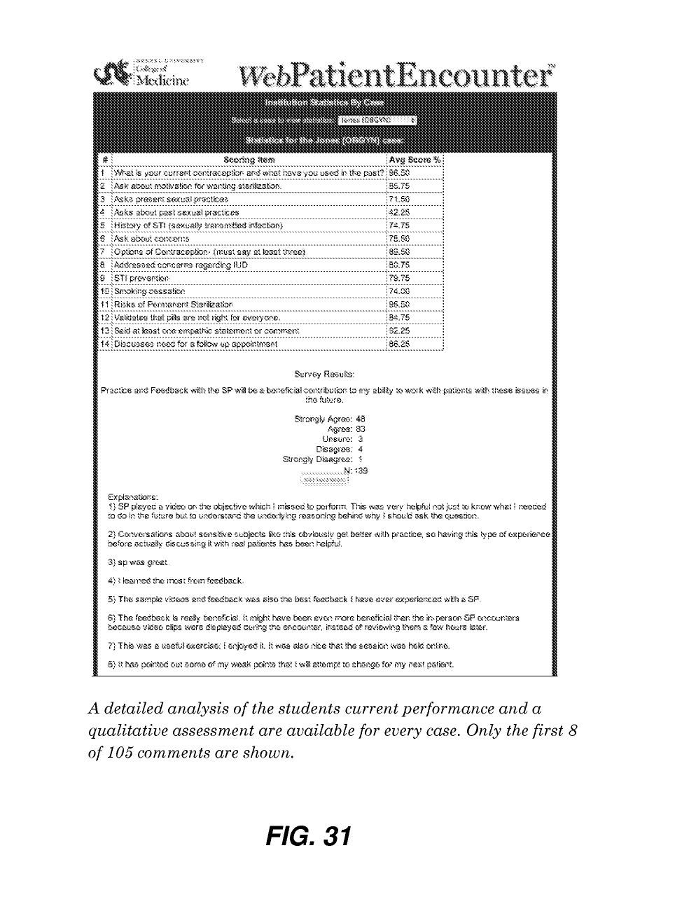

A survey can be accessed at the end of each encounter. A representative beginning of a survey is illustrated in FIG. 30. Referring additionally to FIG. 31, this functionality provides the administration with statistics on the survey data on the effect of the training experience on the future practice and the perceived case quality that are collected after each case. The survey results provide a list of all survey items for a case and the average score per survey item. This allows the educators to see where the trainees have issues. In the screen shot of FIG. 31, item 4 scores low. An assessment can be made if the trainee asks the SP about past sexual practices. As a consequence the faculty can emphasize asking about past sexual practices and then monitor using the “View Statistics” functionality if the trainees improve.

The surveys further provide the results of the post-encounter surveys in a format that can be used for research. For example, the survey can first present the survey question, e.g., “Practice and Feedback with the SP will be a beneficial contribution to my ability to work with patients with these issues in the future” and then provides the answers on a 5-point Likert scale. In the example (N=139), it can be determined that 48 agree strongly, 83 agree, 3 are unsure, 4 disagree, and 1 disagrees strongly. It provides free text comments from the trainee on how the trainee dealt with the case and where they see room for improvement. In the shown case, completion of the survey was optional.

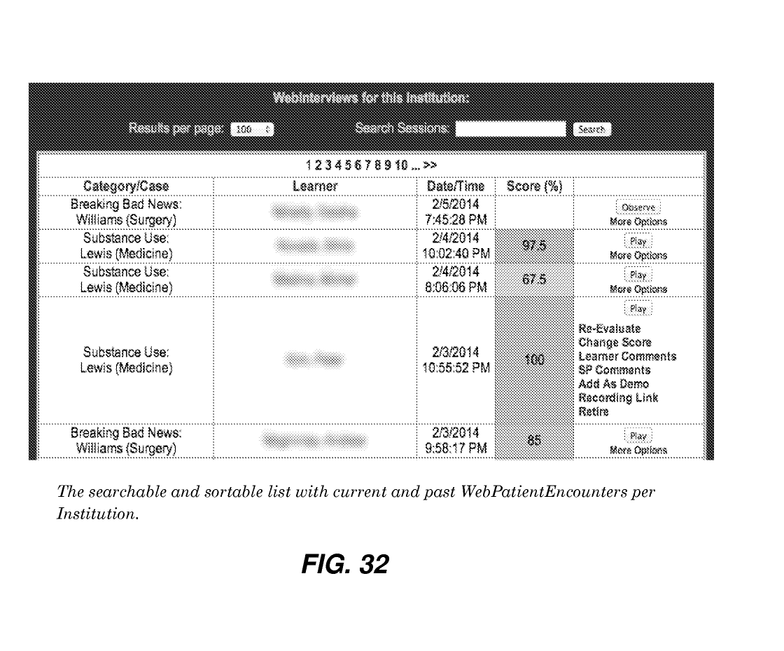

The system can also provide a list of encounters based on criteria, such as for an institution, for example. An example list of encounters is shown in FIG. 32. The list with the current and past encounters offers functionalities in addition to showing the score and allowing review of “recordings” of past encounters. This “Score (%)” field in the example can be highlighted in green (good), yellow (not so good), and red (not good). Because this illustration can be provided with any number of cases such as 1000 encounters per page, the color coding provides a simple way to identify the trainees who perform at low level, investigate, and help them improve their performance.

The last column of the FIG. 32 allows for “observing” an encounter that is currently occurring. By clicking the “Observe” button, the administrator is able to view an ongoing encounter with video and audio of the trainee and the SP. Both, the SP and the trainee, can be notified that an administrator is observing the encounter. The observer remains unseen and unheard. However, an observer can use the chat feature and enter into the encounter.

The “Play” button allows the play-back of a “recording” of the complete encounter inclusive the feedback part by the administrator. The trainee can receive access to the recording of their session directly after the session conclude and receive an email with a link to their encounter account that shows the recording to be available.

While the present application discusses recording in the present system, “recording” needs need not a recording in the traditional sense, but can also encompass an audiovisual representation of time-stamped data that describes what happened when during the encounter and the feedback session. The system concatenates the parts together to make it behave like one recording. However, this recording is the not one recording, but 4 separate video recordings including the trainee encounter, SP encounter, trainee feedback, and SP feedback, that are displayed in synchronization with a timeline that is created by the system using the time stamped data from the database.

Additional functionalities are of the system can be initiated by clicking “More Options”. As shown in FIG. 32, exemplary functions can include “Re-Evaluate” that shows the encounter again and allows the admin to do the scoring, “Change Score” that allows an administrator to enter a different numeric score, “Learner Comments” that displays the learner's comments on the case, “SP Comments” that displays the SP's comments on the case, “Add as Demo” that designates the recording as available to SPs in training of that case, “Recording Link” that provides a secure URL (part of the URL is auto-generated password) to this WPE's recording that can be shared with others who then can watch the recording without having to log in, and “Retire” that removes the recording from the list.

The system is provided with a plurality of system cases. Each of the cases can be represented by three or more SPs. The cases can be off the shelf “ready to use—anytime—anywhere” cases to provide sufficient variability and to demonstrate usability. The following table shows several representative cases that are categorized as “basic cases”, “advanced cases”, “counseling cases”, and one case specific for use by IMGs. The cases number and content were chosen based on empirical data for providing a comprehensive and clinical relevant selection of basic and advanced healthcare communication skills.

Table 1 depicts 20 proposed cases and how they apply to different target groups.

TABLE 1

| | | | International |
|---|---|---|---|
| | Medical | | Medical |
| CASE TOPIC | Students | Residents | Graduates |
| BASIC CASES | X | X | X |
| Depression first time diagnosis | X | X | X |
| Depression and PTSD (including VA) | X | X | X |
| Diabetes first time diagnosis | X | X | X |
| Headache | X | X | X |
| Headache in patient who suffers domestic violence | X | X | X |
| STD (taking sexual history) | X | X | X |
| Substance use diagnosis (patient in pain who seeks | X | X | X |
| relieve by drugs) | | | |
| Interview with the adolescent patient with dropping | X | X | X |
| grades | | | |
| Dealing with angry spouse of patient | X | X | X |
| ADVANCED CASES | | | |
| Giving Bad News in Surgery (patient's father needs a | X | X | X |
| very risky surgery) | | | |
| Giving Bad News in OBS/GYN (pregnancy loss) | X | X | X |
| Alcohol (Diagnosis and initial counseling) | X | X | X |
| Discuss Advance Directives with relatives of patient | X | X | X |
| Discuss Medical Errors (giving wrong antibiotic, | | X | X |
| caused allergy) | | | |
| Discuss Brain Death with relatives of patient | | X | X |
| COUNSELING CASES | | | |
| High Blood Pressure adherence to treatment | X | X | X |
| counseling | | | |
| Diabetes adherence to treatment counseling | X | X | X |
| Diet and Exercise counseling | X | X | X |
| Smoking Cessation counseling | X | X | X |
| INTRODUCTORY CASE FOR IMGs | | | |
| Encounter with an informed American Patient | | | X |
| (Language, Culture) | | | |

The system can be configured with at least three SPs trained per case. The system can provide and record both video and time durations of the training of SPs. Criteria can be set to permit a potential SP to make the jump to SP for a given case. For example, fifteen hours of training can be needed to become certified as an SP in a case. There can be an initial two hour long face-to-face training that is needed to get to know each other and the remainder of the training can be done remotely via the system. The newly trained SPs can present the case to experienced faculty who then “certify” them for going on-line.

The present system provides a scheduling system where each of the SPs enters their availability. Users then enter a date and time for requesting a specific case, enabling a matching and scheduling of their system encounter.

The system can include a payment system, such as an e-commerce connector, that allows individuals and institutions to pay online for sessions/training and the like.

The present system can be employed in the medical profession as described herein. Other markets, including residency, PA, NP and PT training programs and HMOs and healthcare systems, and other, much larger potential markets beyond medicine (including law, sales, etc., where communication skills are key) are also considered. The system technology features an easy to use case-editor that can be used to enter and run cases of any discipline. By way of example, the system can be utilized to provide remote communication skills training and assessment in fields such as job interview training, training of law school students, and legal professionals, and training of staff with direct contact with customers. The present system provides the opportunity to score individuals and provide comparative effectiveness. The system can provide communication solutions that, in the medical field, for example, increase patient compliance and adherence, increase preventative utilization (vaccines, screenings, behavior change, etc.), advance chronic disease self-management to decrease readmission rates.

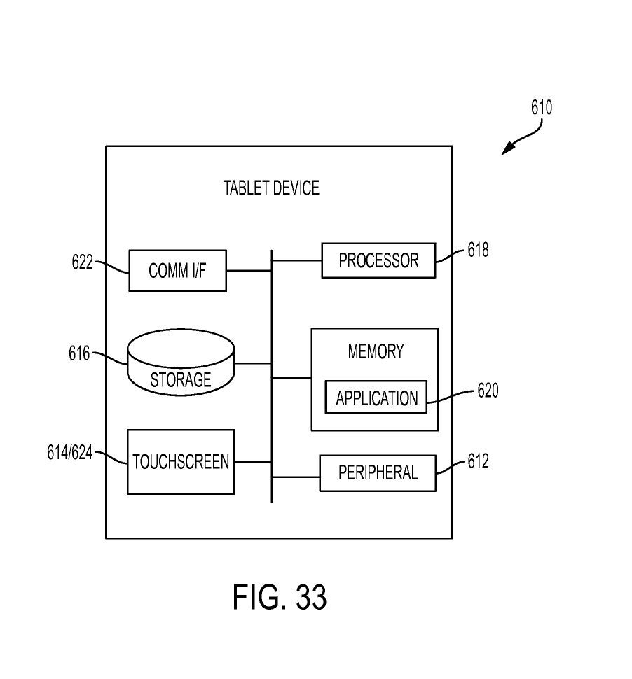

FIG. 33 shows an example computing device 610 that can be used to implement features described above with reference to FIGS. 1-32. The computing device 610 includes a processor 618, memory device 620, communication interface 622, peripheral device interface 612, display device interface 614, and data storage device 616. FIG. 33 also shows a display device 624, which can be coupled to or included within the computing device 610.

The memory device 620 can be or include a device such as a Dynamic Random Access Memory (D-RAM), Static RAM (S-RAM), or other RAM or a flash memory. The data storage device 616 can be or include a hard disk, a magneto-optical medium, an optical medium such as a CD-ROM, a digital versatile disk (DVDs), or Blu-Ray disc (BD), or other type of device for electronic data storage.

The communication interface 622 can be, for example, a communications port, a wired transceiver, a wireless transceiver, and/or a network card. The communication interface 622 can be capable of communicating using technologies such as Ethernet, fiber optics, microwave, xDSL (Digital Subscriber Line), Wireless Local Area Network (WLAN) technology, wireless cellular technology, and/or any other appropriate technology.

The peripheral device interface 612 is configured to communicate with one or more peripheral devices. The peripheral device interface 612 operates using a technology such as Universal Serial Bus (USB), PS/2, Bluetooth, infrared, serial port, parallel port, and/or other appropriate technology. The peripheral device interface 612 can, for example, receive input data from an input device such as a keyboard, a mouse, a trackball, a touch screen, a touch pad, a stylus pad, and/or other device. Alternatively or additionally, the peripheral device interface 612 can communicate output data to a printer that is attached to the computing device 610 via the peripheral device interface 612.

The display device interface 614 can be an interface configured to communicate data to display device 624. The display device 624 can be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 614 can operate using technology such as Video Graphics Array (VGA), Super VGA (S-VGA), Digital Visual Interface (DVI), High-Definition Multimedia Interface (HDMI), or other appropriate technology. The display device interface 614 can communicate display data from the processor 618 to the display device 624 for display by the display device 624. As shown in FIG. 33, the display device 624 can be external to the computing device 610, and coupled to the computing device 610 via the display device interface 614. Alternatively, the display device 624 can be included in the computing device 600.

An instance of the computing device 610 of FIG. 33 can be configured to perform any feature or any combination of features described above as performed by the system. Alternatively or additionally, the memory device 620 and/or the data storage device 616 can store instructions which, when executed by the processor 618, cause the processor 618 to perform any feature or any combination of features described above as performed by the system described. Alternatively or additionally, each or any of the features described above as performed by the system described can be performed by the processor 618 in conjunction with the memory device 620, communication interface 622, peripheral device interface 612, display device interface 614, and/or storage device 616.

Although examples are provided above that relate to a medical service provider, the features described above with reference to FIGS. 1-33 are also applicable and/or can be used by, mutatis mutandis, any type of business, any type of non-business organization, and/or any individual.

As used herein, the term “processor” broadly refers to and is not limited to a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

Although the methods and features are described above with reference to the example architecture of FIGS. 1-33, the methods and features described above can be performed, mutatis mutandis, using any appropriate architecture and/or computing environment. Although features and elements are described above in particular combinations, each feature or element can be used alone or in any combination with or without the other features and elements. For example, each feature or element as described above with reference to FIGS. 1-33 can be used alone without the other features and elements or in various combinations with or without other features and elements. Sub-elements and/or sub-steps of the methods described above with reference to FIGS. 1-33 can be performed in any arbitrary order (including concurrently), in any combination or sub-combination.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments described herein.

The methods or flow charts provided herein can be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. An interactive system for providing a training environment for a first user, the system comprising:
a first computer system programmed to display a first graphical user interface including multiple windows to a first user; and
a second computer system programmed to display a second graphical user interface including multiple windows to a second user;
wherein the first computer system is further programmed to:
display a video feed of the second user within one of the multiple windows in the first graphical user interface; and
capture and relay communications from the first user to the second user;
wherein the second computer system is further programmed to:
display a video feed of the second user within one of the multiple windows in the second graphical user interface;
capture and relay communications from the second user to the first user; and
display a scoring interface within one of the multiple windows in the second graphical user interface;
wherein at least one of the windows of the first user interface and one of the windows of the second user interface involved in the communication are synchronized.

2. The system of claim 1, wherein the first computer system is further programmed to display a graphical representation of patient anatomy in at least one of the multiple windows of the first graphical user interface.

3. The system of claim 2, wherein:
the first computer system is further programmed to detect a selection of a location or region of the graphical representation of patient anatomy and communicate that selection to the second computer system; and
the second computer system is further programmed to display the selection in one of the windows of the second graphical user interface.

4. The system of claim 1, wherein at least one of the first computer system and the second computer system are further programmed to locally store the video feeds.

5. The system of claim 4, wherein at least one of the first computer system and the second computer system are further programmed to locally store other events.

6. The system of claim 4, wherein the other events are multiplexed with the locally stored video feeds.

7. The system of claim 4, wherein:
the second computer system is further programmed to:
receive a playback selection from the second user; and
communicate the playback selection to the first computer system; and
the first computer system is further programmed to obtain locally-stored content corresponding to playback request and display the locally-stored content on the first graphical user interface.

8. The system of claim 7, wherein the playback selection includes at least a start time.

9. The system of claim 7, wherein the second computer system is further programmed to:
display one or more control widgets on the second graphical user interface; and
upon manipulation of the one or more control widgets, communicate instructions to the first computer system to implement playback on the first graphical user interface based on manipulation of the control widgets on the second graphical user interface.

10. The system of claim 9, wherein the one or more control widgets include one or more selected from the group consisting of: a scrollbar, a play button, a pause button, a fast-forward button, and a rewind button.

11. The system of claim 1, wherein the first computer system and the second computer system are programmed to communicate with each other using point-to-point communication.

12. The system of claim 1, wherein:
the second user is a live standardized patient; and
the first user is selected from the group consisting of a medical professional and a trainee standardized patient.

13. An interactive system for providing a training environment for a first user, the system comprising:
a first computer system programmed to display a first graphical user interface including multiple windows to the first user; and
a second computer system programmed to display a second graphical user interface including multiple windows to a second user;
wherein the first computer system is further programmed to:
display a video feed of the second user within one of the multiple windows in the first graphical user interface; and
capture and relay communications from the first user to the second user; and
wherein the second computer system is further programmed to:
display a video feed of the second user within one of the multiple windows in the second graphical user interface;
capture and relay communications from the second user to the first user;
display one or more control widgets on the second graphical user interface; and
upon manipulation of the one or more control widgets, communicate instructions to the first computer system to implement playback on the first graphical user interface based on manipulation of the control widgets on the second graphical user interface.

14. The system of claim 13, wherein at least one of the windows of the first user interface and one of the windows of the second user interface involved in the communication are synchronized.

15. The system of claim 13, wherein the one or more control widgets include one or more selected from the group consisting of: a scrollbar, a play button, a pause button, a fast-forward button, and a rewind button.

16. An interactive system for providing a training environment for a first user, the system comprising:
a first computer system programmed to display a first graphical user interface including multiple windows to a first user; and
a second computer system programmed to display a second graphical user interface including multiple windows to a second user;
wherein the first computer system is further programmed to:
display a video feed of the second user within one of the multiple windows in the first graphical user interface; and
capture and relay communications from the first user to the second user; and
wherein the second computer system is further programmed to:
display a video feed of the second user within one of the multiple windows in the second graphical user interface; and
capture and relay communications from the second user to the first user;
wherein at least one of the first computer system and the second computer system are further programmed to locally store the video feeds;
wherein the second computer system is further programmed to:
receive a playback selection from the second user; and
communicate the playback selection to the first computer system; and
wherein the first computer system is further programmed to obtain locally-stored content corresponding to playback request and display the locally-stored content on the first graphical user interface.

17. The system of claim 16, wherein at least one of the windows of the first user interface and one of the windows of the second user interface involved in the communication are synchronized.

18. The system of claim 16, wherein at least one of the first computer system and the second computer system are further programmed to locally store other events.

19. The system of claim 16, wherein the other events are multiplexed with the locally stored video feeds.

20. The system of claim 16, wherein the playback selection includes at least a start time.
